(19) United States
(12) Patent Application Publication
(10) Pub. No.: US 2026/0336296 A1
(43) Pub. Date: Oct. 29, 2026

(54) INK JET RECORDING APPARATUS

(71) Applicant: KEYENCE CORPORATION, Osaka (JP)

(72) Inventor: Hideki Yamakawa, Osaka-shi (JP)

(73) Assignee: KEYENCE CORPORATION, Osaka (JP)

(21) Appl. No.: 19/649,363

(22) Filed: Apr. 16, 2026

(30) Foreign Application Priority Data
Apr. 25, 2025 (JP) 2025-072963
Feb. 16, 2026 (JP) 2026-023153

(51) Int. Cl. B41J 2/165; B41J 2/045; B41J 2/085; B41J 2/09; B41J 2/175; B41J 2/20

(52) U.S. Cl. CPC B41J 2/16552; B41J 2/0451; B41J 2/04581; B41J 2/085; B41J 2/09; B41J 2/16579; B41J 2/17596; B41J 2/20; B41J 2002/16555

(57) ABSTRACT

To prevent an increase in downtime of a production line in a case where an error related to ink contamination occurs. An ink jet recording apparatus includes a controller. The controller includes: an error detection unit that detects an error related to ink contamination of at least one of a print nozzle, a charging electrode, a deflection electrode, and a gutter provided in a print head, or an error related to a problem of a pump provided in the controller; and a control unit that executes, in a state where the print head is installed in a production line, at least one maintenance operation among a plurality of different maintenance operations using ink or a solvent, according to a type of the error detected by the error detection unit.

### CROSS-REFERENCE TO RELATED APPLICATIONS

The present application claims foreign priority based on Japanese Patent Application No. 2025-072963, filed Apr. 25, 2025, and No. 2026-023153, filed Feb. 16, 2026, the contents of which are incorporated herein by references.

### BACKGROUND OF THE INVENTION

### 1. Technical Field

The disclosure relates to an ink jet recording apparatus.

### 2. Description of the Related Art

For example, JP2021-091181A discloses a so-called continuance-type ink jet recording apparatus in which ink is circulated inside the apparatus even when printing is not performed on a workpiece. In the case of a continuance-type ink jet recording apparatus, ink particles continue to fly in an internal space of a print head thereof. Therefore, since ink contamination is likely to accumulate inside the print head, it is necessary to appropriately clean the inside.

For example, cleaning (head cleaning) of the print head is performed by spraying a solvent into the print head by a user himself or herself or by placing the print head on a cleaning and placing unit and ejecting the solvent from a cleaning nozzle.

### SUMMARY OF THE INVENTION

Meanwhile, when ink contamination accumulates inside the print head during operation of the ink jet recording apparatus, a printing error such as a deflection electrode leak error may occur, for example. The deflection electrode leak error means an error in an electric leakage state in which a voltage of the deflection electrode cannot be normally maintained. In a case where such a printing error occurs, the user performs the above-described head cleaning to attempt recovery of the apparatus.

However, in a case where a print head is removed from a production line and head cleaning is performed, work such as removal of the print head, head cleaning, and attachment of the print head occurs. Therefore, it takes a long time to recover from a printing error, and as a result, there is a problem that downtime of the production line is prolonged, for example. Furthermore, in a case where the cause of the printing error is on the controller side, the error is not recovered even if head cleaning is performed, and further time is required to identify and deal with the cause, and as a result, there is a problem that the downtime of the production line is prolonged.

The disclosure has been made in view of such a point, and an object thereof is to prevent an increase in downtime of a production line in a case where an error related to ink contamination of the print head occurs or a problem inside the controller occurs.

In order to achieve the above object, according to one embodiment of the disclosure, it is possible to assume an ink jet recording apparatus includes: a print head configured to accommodate a print nozzle configured to eject particulate ink, a charging electrode configured to charge the particulate ink ejected from the print nozzle, a deflection electrode configured to deflect a flight direction of the ink charged by the charging electrode, and a gutter configured to collect the ink not deflected by the deflection electrode, the print head being configured to eject the ink deflected by the deflection electrode to an outside; a controller including a pump, configured to supply ink or a solvent to the print head using the pump and send a control signal for controlling the print nozzle, the charging electrode, and the deflection electrode to the print head; and a connection cable configured to fluidly and electrically connect the print head and the controller, the ink jet recording apparatus being configured to perform printing on a workpiece flowing through a production line in a state where the print head is installed in the production line.

The controller includes: an error detection unit configured to detect an error related to ink contamination of at least one of the print nozzle, the charging electrode, the deflection electrode, and the gutter provided in the print head, or an error related to a problem of the pump provided in the controller; and a control unit configured to, in a state where the print head is installed in the production line, execute at least one maintenance operation among a plurality of different maintenance operations using ink or a solvent, according to a type of the error detected by the error detection unit.

According to this configuration, when printing is performed on the workpiece flowing through the production line, in a case where at least one of the print nozzle, the charging electrode, the deflection electrode, and the gutter of the print head is contaminated by adhesion of ink, the error detection unit detects an error related to ink contamination. The error related to the ink contamination may be an error detected at the stage when printing cannot be performed or an error detected before printing cannot be performed, but regardless of the error, for example, an in-line cleaning operation is performed as a maintenance operation in a state where the print head is installed in the production line. In this in-line cleaning operation, since the cleaning operation according to the type of the error is executed, the cleaning efficiency increases, and the time required for the recovery of the ink jet recording apparatus can be shortened. Furthermore, in a case where an error related to a problem of the pump provided in the controller is detected, as a maintenance operation, sticking release processing for releasing pump sticking is executed.

As described above, even in a case where a printing error occurs, it is possible to clean the print head without removing the print head from the production line and attempt to recover from the error, and thus, it is possible to reduce the downtime. Note that, if the print head is configured to be automatically cleaned without being removed from the production line, it is possible to further reduce the downtime since the manual operation is not involved. Furthermore, even in a case where an error related to a problem inside the controller occurs, downtime can be reduced.

### BRIEF DESCRIPTION OF THE DRAWINGS

FIG. 1 is a diagram illustrating an overall configuration of an ink jet recording apparatus;

FIG. 2 is a block diagram illustrating a schematic configuration of the ink jet recording apparatus;

FIG. 3 is a diagram illustrating a schematic configuration of a print head;

FIG. 4A is a diagram illustrating a schematic configuration of the print head;

FIG. 4B is a diagram illustrating a schematic configuration of the print head;

FIG. 5 is a diagram illustrating paths of ink and a solvent in the ink jet recording apparatus;

FIG. 6 is a block diagram illustrating a schematic configuration of an air injection module;

FIG. 7 is a flowchart illustrating an operation (basic cleaning operation) at the time of cleaning using high-pressure air;

FIG. 8 is a flowchart illustrating an operation at the time of cleaning without using high-pressure air;

FIG. 9 is a flowchart illustrating processing when an error occurs;

FIG. 10 is a flowchart illustrating processing A when an error occurs;

FIG. 11A is a cross-sectional view of a print nozzle;

FIG. 11B is a view corresponding to FIG. 11A after droplet formation control;

FIG. 11C is a view corresponding to FIG. 11A after suction control;

FIG. 12 is a path diagram at the time of sticking check of a first pump;

FIG. 13 is a path diagram at the time of sticking check of a second pump;

FIG. 14 is a path diagram at the time of sticking check of a third pump;

FIG. 15 is a path diagram at the time of sticking check of a fourth pump;

FIG. 16 is a path diagram at the time of releasing sticking of the second pump;

FIG. 17 is a path diagram at the time of releasing sticking of the first pump;

FIG. 18 is a path diagram at the time of releasing sticking of the third pump;

FIG. 19 is a path diagram at the time of releasing sticking of the fourth pump;

FIG. 20 is a flowchart illustrating processing C when an error occurs;

FIG. 21 is a diagram for describing a first operation mode using a spare body;

FIG. 22 is a diagram for describing a second operation mode using the spare body;

FIG. 23 is a diagram corresponding to FIG. 5 illustrating a state where a head module is removed;

FIG. 24 is a flowchart illustrating maintenance processing in a state where the head module is removed;

FIG. 25 is a diagram illustrating an example in which a member in a path state different from that at the time of printing by the head module is attached;

FIG. 26 is a flowchart illustrating processing in a case where an error is output even if there is no trigger input; and

FIG. 27 is a flowchart illustrating processing in a case where an error is output after a trigger is input.

### DETAILED DESCRIPTION

Hereinafter, embodiments of the invention will be described in detail with reference to the drawings. Note that the following description of preferred embodiments is merely exemplary in nature and is not intended to limit the invention, its application, or its use. For example, the relative size and positional relationship of each member illustrated in the drawings are for describing one embodiment, and do not limit the invention.

In the present specification, an industrial ink jet printer will be described as an example of an ink jet recording apparatus, but the technology disclosed herein can be applied to general equipment configured to cause particulate ink (hereinafter, also referred to as ink particles) to fly and land on a printing material such as a workpiece regardless of the names of the ink jet recording apparatus and the industrial ink jet printer.

Furthermore, in the present specification, printing by the ink jet recording apparatus will be described, but the “printing” here includes, for example, all processing processes applying ink jet, such as printing of characters, marking of figures, and the like.

### Overall configuration

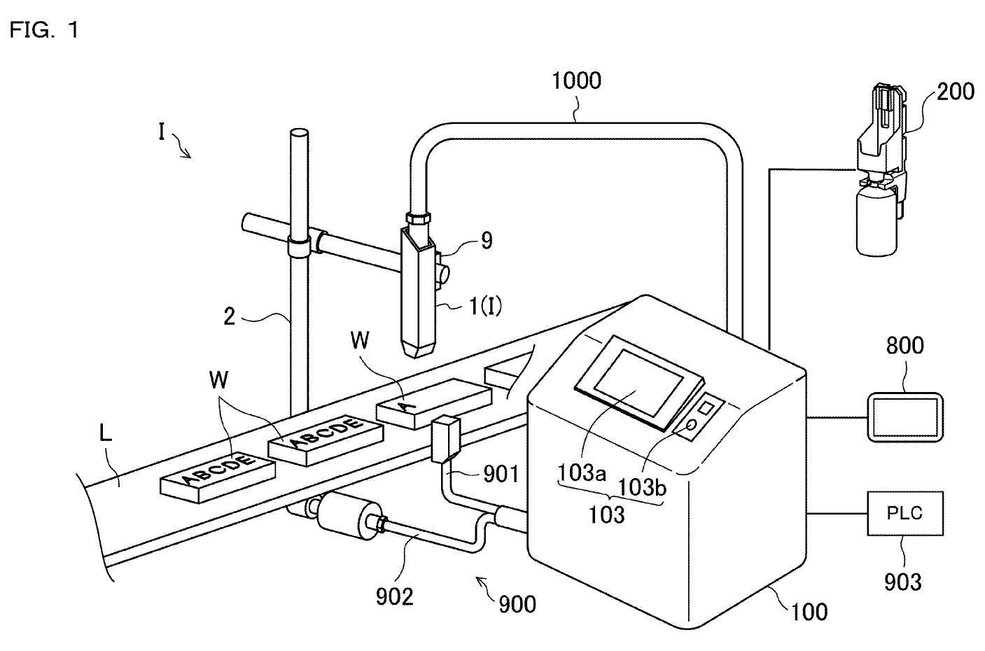

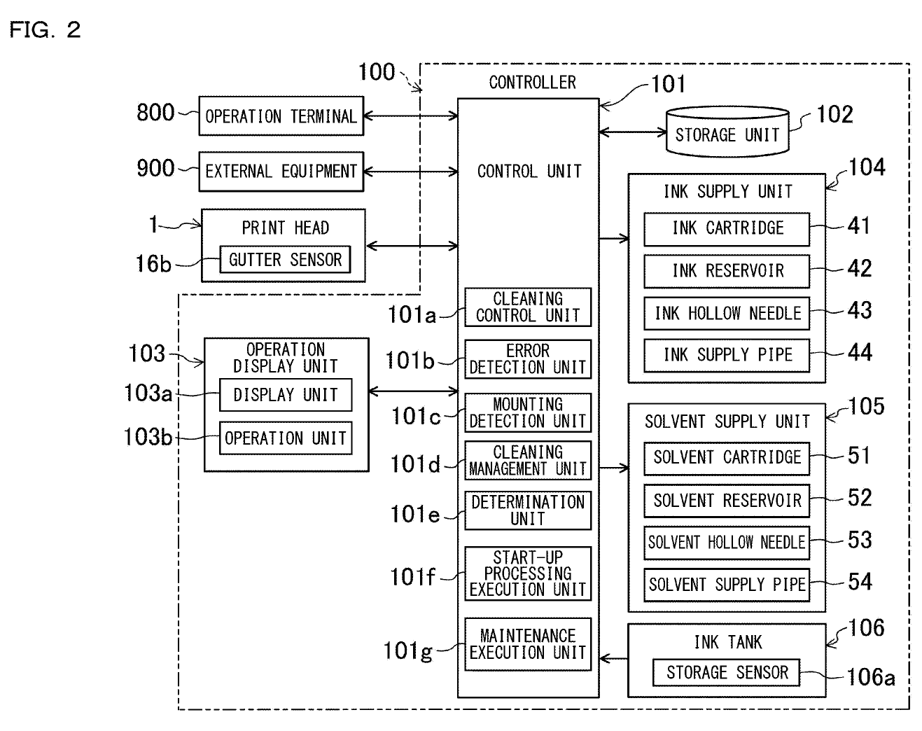

FIG. 1 is a diagram illustrating an overall configuration of an ink jet recording apparatus I. Furthermore, FIG. 2 is a diagram illustrating a schematic configuration of the ink jet recording apparatus I. The ink jet recording apparatus I illustrated in FIG. 1 is installed in a conveyance line (production line) L of a factory or the like, for example, and is configured to sequentially perform printing on each printing material W flowing through the conveyance line L. The conveyance line L can be configured by, for example, a belt conveyor or the like.

The ink jet recording apparatus I includes a print head 1 that ejects ink particles from a print nozzle 12 and causes the ink particles to land on a printing material W, a controller 100 that supplies a control signal, ink, and a solvent to the print head 1, and a connection cable 1000 that connects the print head 1 and the controller 100. The controller 100 supplies a control signal to the print head 1 to control the locus of the ink particles. Therefore, the landing position of the ink particles on the printing material W is adjusted, and desired printing is realized. The print head 1 is fixed at a predetermined position by a support member 2 or the like.

The ink jet recording apparatus I is a continuous ink jet printer (CIJ). That is, in order to prevent clogging (in particular, clogging of the print nozzle 12) and the like due to volatilization of the ink, even when the ink jet recording apparatus I is not executing printing, the ink always circulates inside the ink jet recording apparatus I as long as the ink jet recording apparatus I is in an operating state. By adopting the continuous type, a quick-drying ink can be used without causing clogging by the ink. Furthermore, the ink jet recording apparatus I according to the present embodiment can adjust the concentration (viscosity) of the ink by mixing the solvent and the ink.

Furthermore, the ink jet recording apparatus I according to the present embodiment supplies a liquid that dissolves ink from the controller 100 to the print head 1 in cleaning processing to be described later. This liquid is used for cleaning in the print head 1. In the present embodiment, the solvent for adjusting the concentration (viscosity) of the ink is used for the liquid that dissolves the ink and is used for cleaning in the print head 1.

In a case where a solvent is used for the liquid, the solvent used for cleaning in the print head 1 can be collected as needed and reused to adjust the concentration (viscosity) of the ink or reused for further cleaning in the print head 1.

Note that it is not essential to use a solvent for adjusting the concentration (viscosity) of the ink for the liquid for the cleaning processing. Any liquid that can dissolve the ink, such as an organic solvent including ethanol, can be used for the cleaning processing.

The ink jet recording apparatus I according to the present embodiment also includes a cleaning and placing unit 200 used when cleaning the print head 1. Details of the cleaning and placing unit 200 will be described later. Note that the cleaning and placing unit 200 may be provided as necessary, and may be omitted.

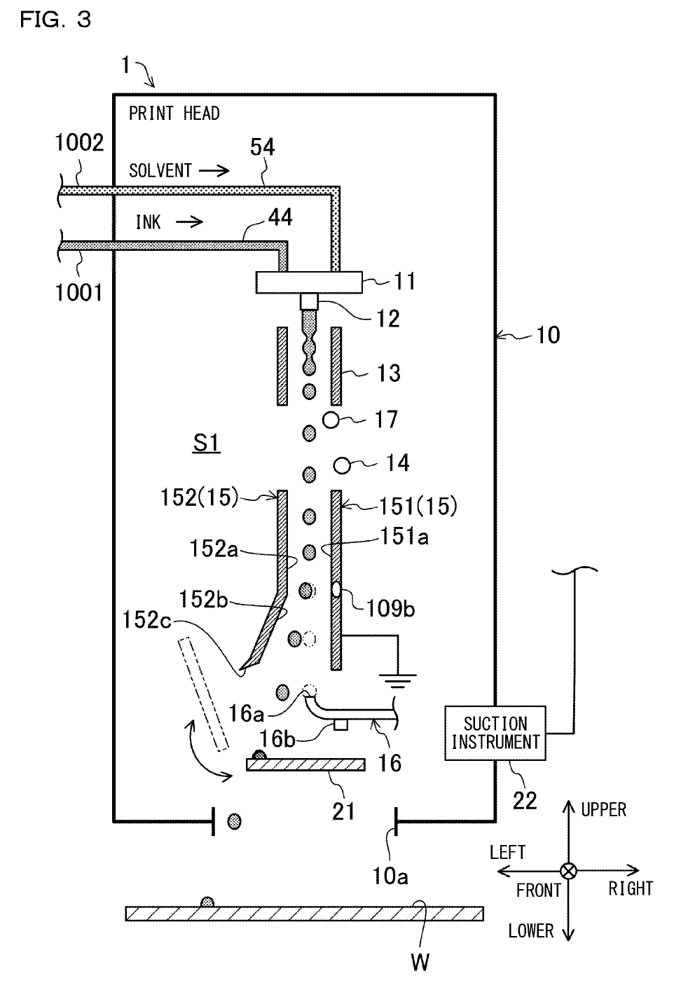

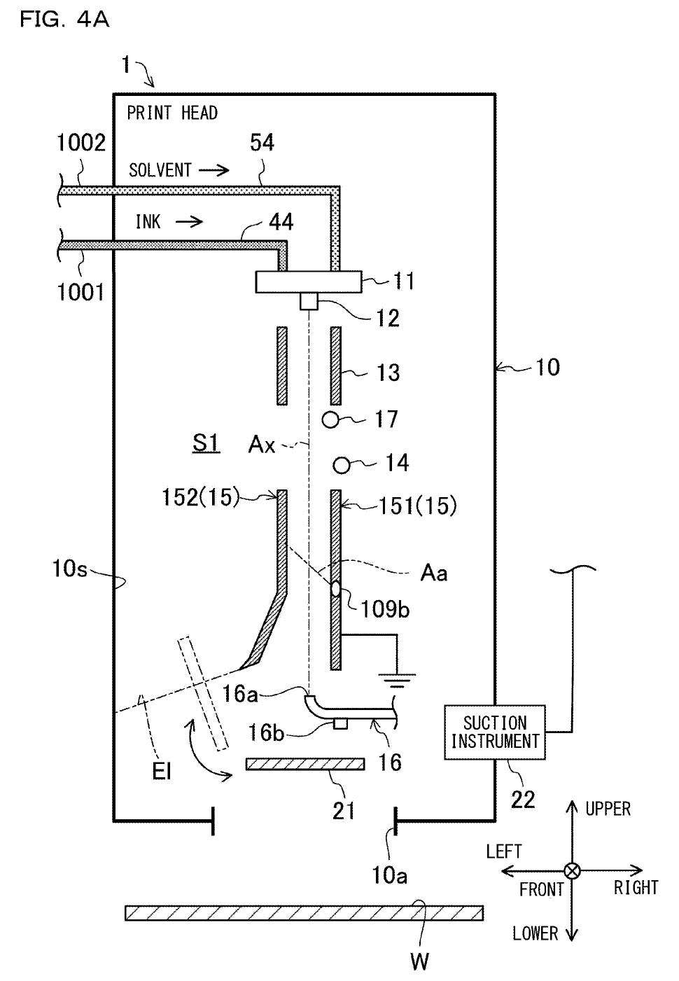

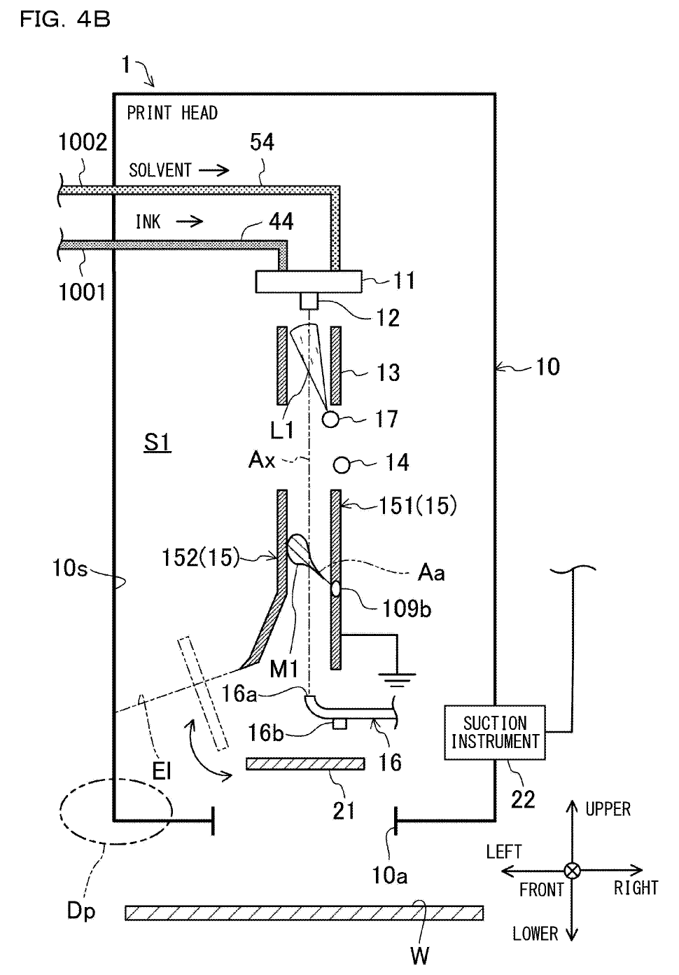

In order to realize the circulation of the ink, the print head 1 includes a gutter 16 that collects the ink or the solvent ejected from the print nozzle 12 in addition to the print nozzle 12 that ejects the ink or the solvent (see FIGS. 3, 4A, and 4B). The ink or solvent fed from the controller 100 to the print head 1 is ejected from the print nozzle 12 and collected by the gutter 16.

The ink jet recording apparatus I includes an operation terminal 800. The operation terminal 800 includes, for example, a central processing unit (CPU) and a storage device, and is connected to the controller 100. The operation terminal 800 defines print settings and functions as a terminal for indicating information related to printing to the user. The print settings set by the operation terminal 800 are output to the controller 100 and stored in the storage unit 102.

The ink jet recording apparatus I includes external equipment 900. The external equipment 900 is connected to the controller 100 as necessary. In the example illustrated in FIGS. 1 and 2, a workpiece detection sensor 901, a conveyance speed sensor 902, and a programmable logic controller (PLC) 903 are provided as the external equipment 900.

The workpiece detection sensor 901 detects the presence or absence of the printing material W on the conveyance line L, and outputs a signal (detection signal) indicating the detection result to the controller 100. The detection signal output from the workpiece detection sensor 901 functions as a trigger (print trigger) for starting printing.

The conveyance speed sensor 902 includes, for example, a rotary encoder, and can detect the conveyance speed of the printing material W. The conveyance speed sensor 902 outputs a signal (detection signal) indicating the detection result to the controller 100. The controller 100 controls timing and the like of ejecting the ink particles from the print head 1 on the basis of the detection signal input from the conveyance speed sensor 902.

As illustrated in FIG. 2, the PLC 903 is electrically connected to the controller 100. The PLC 903 is used to control the ink jet recording apparatus I according to a predetermined sequence.

### Controller 100

The controller 100 is configured to supply ink to the print head 1 and send control signals to the print head 1 to control components of the print head 1. Here, the components of the print head 1 include a print nozzle 12, a charging electrode 13, and a deflection electrode 15, which will be described later. The controller 100 also supplies a solvent for diluting the ink to the print head 1 in addition to the ink for printing.

The controller 100 includes, as components related to electrical control, a storage unit 102 that stores the above-described print settings, a control unit 101 that controls the controller 100 and each portion of the print head 1, and an operation display unit 103 that receives an operation by a user and displays information to the user.

The controller 100 also includes an ink supply unit 104, a solvent supply unit 105, and an ink tank 106 as components related to supply of ink and the like. These components are in direct or indirect fluid connection with the print head 1. At least in the present embodiment, the controller 100 accommodates the ink supply unit 104, the solvent supply unit 105, and the control unit 101 therein.

The ink supply unit 104 includes an ink reservoir 42 that detachably receives an ink cartridge 41 in which ink is accommodated. The ink supply unit 104 supplies ink to the print head 1. Meanwhile, the solvent supply unit 105 includes a solvent reservoir 52 that detachably receives a solvent cartridge 51 accommodating a solvent. The solvent supply unit 105 supplies a solvent to the print head 1. In the cleaning processing described below, the solvent supply unit 105 supplies a liquid (solvent in the present embodiment) that dissolves ink to the print head 1.

The ink tank 106 stores the ink from the ink cartridge 41 received in the ink reservoir 42 and the solvent from the solvent cartridge 51 received in the solvent reservoir 52 as printing ink. The “printing ink” herein means a mixture of a solvent and an ink (for example, ink whose concentration is adjusted by a solvent).

The print head 1 performs printing using the printing ink from the ink tank 106. The print head 1 also cleans each part in the print head 1 such as the print nozzle 12 by the solvent supplied from the solvent supply unit 105 while bypassing the ink tank 106.

The storage unit 102 is configured to store print settings set via the operation display unit 103 or the operation terminal 800 described later, and output the stored print settings to the control unit 101 on the basis of a control signal from the outside. The storage unit 102 may store information related to head cleaning. The information related to head cleaning includes information related to processing performed by a cleaning control unit 101a. The information related to the processing performed by the cleaning control unit 101a includes the cleaning pattern of the head cleaning and the cleaning time of the head cleaning.

The control unit 101 is a processing unit that controls ink supply from the ink supply unit 104 to the print head 1 and controls solvent supply from the solvent supply unit 105 to the print head 1. Specifically, the control unit 101 controls at least the ink supply unit 104 and the solvent supply unit 105 in the controller 100 and the print nozzle 12, the charging electrode 13, and the deflection electrode 15 in the print head 1 on the basis of the print settings stored in the storage unit 102. The control unit 101 controls each unit to perform printing on the printing material W at a predetermined timing.

The control unit 101 includes, for example, a CPU, a memory, an input/output bus, and the like, and generates a control signal on the basis of a signal indicating information input via the operation display unit 103 or the operation terminal 800 and a signal indicating a print setting read from the storage unit 102. The control unit 101 outputs the control signal thus generated to each unit to control printing on the printing material W.

For example, when printing is performed on the printing material W, the control unit 101 reads the print content on the printing material W stored in the storage unit 102 and generates a control signal based on the print content. Then, the control unit 101 outputs the control signal to the charging electrode 13 to set the flight direction of the ink particles so as to realize the landing position corresponding to the print content.

As illustrated in FIG. 1, the operation display unit 103 includes a display unit 103a that displays information to the user and an operation unit 103b that receives an operation by the user. The display unit 103a displays various types of information related to the ink jet recording apparatus I. The display unit 103a includes, for example, a liquid crystal display panel, an organic EL display panel, or the like, and changes a display mode in response to a control signal from the control unit 101. The display unit 103a can display a user interface for operating each unit of the ink jet recording apparatus I, a user interface for setting print settings, and a user interface related to head cleaning.

The operation unit 103b includes, for example, a touch operation panel, a button, a switch, and the like. When the user operates the operation unit 103b, information (operation information) corresponding to the operation input is input to the control unit 101, and the control unit 101 can detect what operation has been performed. For example, by operating the operation unit 103b, it is possible to switch the power supply ON/OFF and the like of the ink jet recording apparatus I, and to perform various settings, input information, and the like. The operation display unit 103 can also set print settings similarly to the operation terminal 800 described above.

The ink supply unit 104 supplies the ink from the ink cartridge 41 to the print nozzle 12 of the print head 1 as printing ink. At this time, the ink from the ink supply unit 104 is supplied to the print head 1 via the ink tank 106.

Specifically, the ink supply unit 104 according to the present embodiment includes the ink cartridge 41 and the ink reservoir 42 described above, the ink hollow needle 43, and the ink supply pipe 44. The ink hollow needle 43 fluidly connects the ink cartridge 41 and the ink supply pipe 44. The ink supply pipe 44 fluidly connects the ink cartridge 41 and the print head 1 via the ink hollow needle 43 and the connection cable 1000. The ink tank 106 is disposed in the middle of the ink supply pipe 44 from the ink hollow needle 43 to the print head 1.

The ink cartridge 41 accommodates ink. The ink reservoir 42 detachably receives the ink cartridge 41. By replacing the ink cartridge 41 with respect to the ink reservoir 42, ink can be replenished to the ink tank 106.

The ink supply pipe 44 constitutes a path for supplying printing ink to the print head 1 together with the connection cable 1000 described later. Ink can be circulated between the print head 1 and the controller 100 by the path constituted by the ink supply pipe 44.

The ink supply pipe 44 is provided with a plurality of on-off valves including a first valve V1 and a plurality of pumps including a first pump P1. Among these, since each on-off valve is constituted by an electromagnetic valve, each on-off valve is hereinafter also simply referred to as an electromagnetic valve. Each on-off valve can open and close in response to a control signal output from the control unit 101 to control the flow of ink. On the other hand, each pump receives a control signal output from the control unit 101 to pressure-feed the ink, and can control the flow of the ink similarly to the on-off valve.

The solvent supply unit 105 supplies the solvent from the solvent cartridge 51 to the ink tank 106 similarly to the ink, or supplies the solvent alone to the print nozzle 12. The former solvent forms a printing ink together with the ink by adjusting the concentration of the ink, and is supplied to the print head 1.

In a case where printing is performed by the print head 1, the solvent from the solvent supply unit 105 is guided to the print nozzle 12 via the ink tank 106. On the other hand, in a case of being supplied as a solvent alone (for example, in a case of performing cleaning of the print head 1 to be described later), the solvent from the solvent supply unit 105 is guided to the print nozzle 12 without passing through the ink tank 106.

The solvent cartridge 51 accommodates a solvent. The solvent reservoir 52 detachably receives the solvent cartridge 51. By replacing the solvent cartridge 51 with respect to the solvent reservoir 52, it is possible to replenish the solvent for concentration adjustment and the solvent for cleaning.

The solvent supply unit 105 includes the solvent cartridge 51 and the solvent reservoir 52 described above, a solvent hollow needle 53, and a solvent supply pipe 54. The solvent hollow needle 53 fluidly connects the solvent cartridge 51 and the solvent supply pipe 54. The solvent supply pipe 54 fluidly connects the solvent cartridge 51 and the print head 1 to the solvent cartridge 51 and the ink tank 106 via the solvent hollow needle 53 and the connection cable 1000, respectively.

The solvent cartridge 51 accommodates a solvent. The solvent reservoir 52 detachably receives the solvent cartridge 51. By replacing the solvent cartridge 51 with respect to the solvent reservoir 52, it is possible to replenish the solvent for concentration adjustment and the solvent for cleaning.

The solvent supply pipe 54 constitutes a path for supplying a solvent to the ink tank 106 or supplying a solvent to the print head 1 without interposing the ink tank 106, together with the connection cable 1000 described later. These paths allow printing inks to be produced from the ink and solvent, and the print head 1 to be cleaned with the solvent.

The solvent supply pipe 54 is provided with a plurality of on-off valves including a 12th valve V12 and a plurality of pumps including a second pump P2. Among these, since each on-off valve is constituted by an electromagnetic valve, each on-off valve is hereinafter also simply referred to as an electromagnetic valve. Each on-off valve can open and close in response to a control signal output from the control unit 101 to control the flow of the solvent. On the other hand, each pump receives a control signal output from the control unit 101, pumps the solvent, and can control the flow of the solvent similarly to the electromagnetic valve.

The ink tank 106 is a member that stores the ink from the ink cartridge 41 and the solvent from the solvent cartridge 51, and is configured by a container that accommodates ink whose concentration (viscosity) is adjusted by the solvent, that is, a mixture of the ink and the solvent. The printing ink supplied from the ink tank 106 to the print nozzle 12 lands on a surface of the printing material W at the time of printing, and is collected by the gutter 16 and sent back to the ink tank 106 at the time of non-printing. This achieves circulation of the printing ink. The solvent supplied to the print nozzle 12 for cleaning is also collected by the gutter 16, and then sent to the ink tank 106 through, for example, a conditioning tank 107 dedicated to the solvent, and can be reused for ink concentration adjustment.

The ink tank 106 is provided with a storage sensor 106a (illustrated in FIG. 2) for detecting a liquid level (so-called fluid level) in the tank. The storage sensor 106a is electrically connected to the control unit 101, and inputs a detection signal thereof to the controller 100.

The connection cable 1000 fluidly and electrically connects the print head 1 and the controller 100. The connection cable 1000 has flexibility and is connected to the upper end portion of the print head 1 (see FIG. 1). One end portion of the connection cable 1000 is connected to the print head 1, and the other end portion is connected to the controller 100. The connection cable 1000 is formed by bundling a power supply wiring for sending and receiving a control signal between the print head 1 and the controller 100, an ink tube 1001 for sending and receiving ink therebetween, and a solvent tube 1002 for sending and receiving a solvent therebetween (see FIGS. 3, 4A, and 4B). The ink tube 1001 for sending and receiving ink between the print head 1 and the controller 100 is continuous with the ink supply pipe 44. The solvent tube 1002 for sending and receiving a solvent between the print head 1 and the controller 100 is continuous with the solvent supply pipe 54.

The print head 1 ejects ink (printing ink) whose concentration has been adjusted on the basis of a control signal supplied from the controller 100, the ink, and a solvent into particulate ink (hereinafter, also referred to as “ink particles”). The print head 1 can perform printing on the printing material W by deflecting the flight direction of the ejected ink particles and causing the deflected ink particles to land on the surface of the printing material W. The details of printing at that time are in accordance with the above-described print setting. The print head 1 can sequentially perform printing on each of the printing materials W according to the print setting.

As illustrated in FIG. 3, the print head 1 includes a pressurizer 11, a print nozzle 12, a charging electrode 13, a deflection electrode 15, a gutter 16, a cleaning nozzle 17, a shutter 21, and a suction instrument 22. The pressurizer 11 pressurizes the printing ink to form a particulate ink. The print nozzle 12 ejects particulate ink. The charging electrode 13 charges the particulate ink ejected from the print nozzle 12. The deflection electrode 15 deflects flight deflection of the printing ink charged by the charging electrode 13. The gutter 16 collects the printing ink not deflected by the deflection electrode 15 or the solvent ejected from the print nozzle 12. Moreover, the print head 1 includes a charge detection sensor 14 that monitors a charge state of the printing ink, and a gutter sensor 16b that detects whether or not the ink is in the gutter 16.

The print head 1 includes a housing 10 that accommodates the pressurizer 11, the print nozzle 12, the charging electrode 13, the charge detection sensor 14, the deflection electrode 15, the gutter 16, the gutter sensor 16b, and the cleaning nozzle 17 therein and defines a flight space S1 of the ink particles. The print head 1 ejects the ink particles deflected by the deflection electrode 15 to the outside of the housing 10 through the flight space S1.

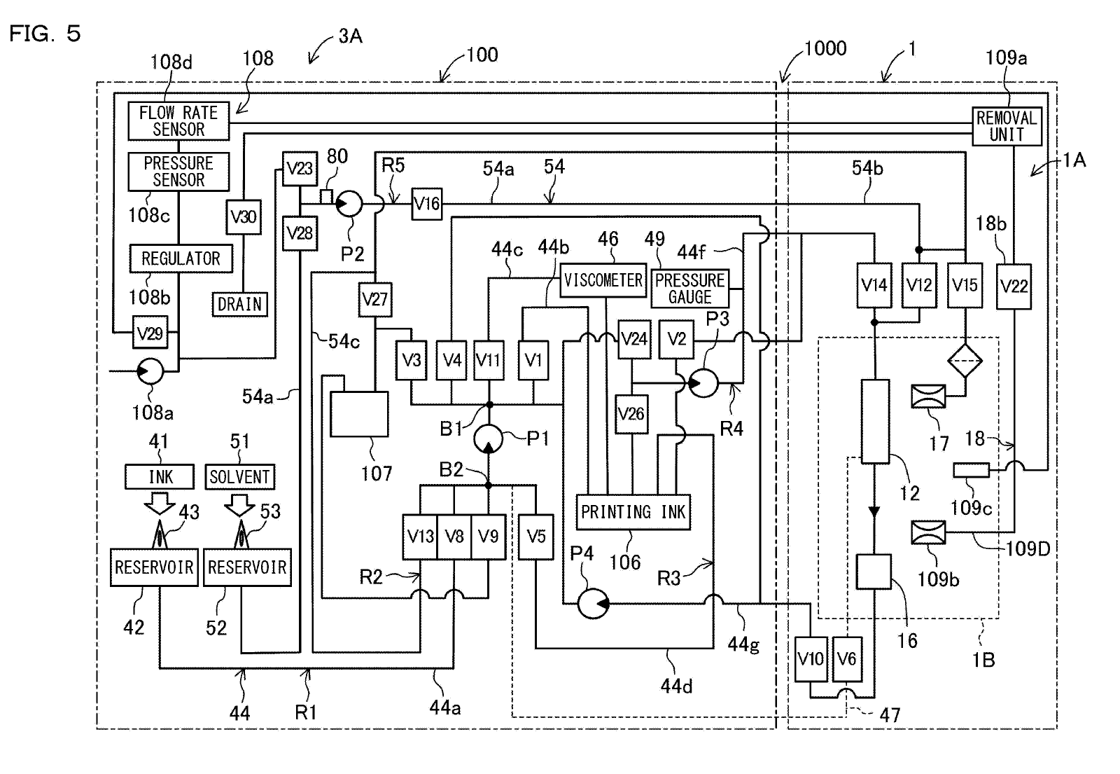

As illustrated in FIG. 5, the print head 1 includes the head body 1A to which the connection cable 1000 is connected and which supplies ink to the print nozzles 12 via the connection cable 1000, and the head module 1B detachably attached to the head body 1A and accommodating the print nozzles 12. The head module 1B includes a pressurizer 11, a print nozzle 12, a charging electrode 13, a deflection electrode 15, and a gutter 16. The pressurizer 11, the print nozzle 12, the charging electrode 13, the deflection electrode 15, and the gutter 16 are attached to and integrated with a base portion of the head module 1B. By attaching the base portion of the head module 1B to the head body 1A, a printable state is obtained.

As will be described in detail later, the head module 1B can be replaced with another head module. For example, in a case where the head module 1B in use fails, a normally operating head module is prepared, the head module 1B is removed from the head body 1A, and then the normally operating head module is attached to the head body 1A. Note that the head module 1B may not include all of the pressurizer 11, the print nozzle 12, the charging electrode 13, the deflection electrode 15, and the gutter 16, and may include at least one of these members.

As illustrated in FIG. 2, the controller 100 includes a mounting detection unit 101c that detects whether or not the head module 1B is mounted to the head body 1A. Examples of the mounting detection unit 101c include, but are not limited to, a proximity sensor that outputs an ON signal in a case where the head module 1B is mounted to the head body 1A, a sensor using a magnetic force, a sensor that forms an electrical contact, and the like.

As illustrated in FIGS. 3, 4A, and 4B, the housing 10 extends in an upper-lower direction. In the following description, a longitudinal direction of the housing 10 is simply referred to as “upper-lower direction”, while two directions orthogonal to the upper-lower direction are referred to as “front-rear direction” and “left-right direction”, respectively. In other drawings, directions corresponding to these directions are referred to as “upper-lower direction”, “front-rear direction”, and “left-right direction”, respectively. “Upper” refers to the upper side of FIG. 3, and “lower” refers to the lower side. Note that the print head 1 does not necessarily have its upper-lower direction along a vertical direction (gravity direction). The print head 1 may also be in an attitude with its upper-lower direction along a horizontal direction.

The print head 1 includes an ink ejection port 10a for ejecting the ink deflected by the deflection electrode 15 to the outside. The ink ejection port 10a opens on the lower surface of the housing 10. Hereinafter, the ink ejection port 10a is also simply referred to as an ejection port 10a. The ink particles are ejected from the ejection port 10a toward the lower side of the housing 10.

As illustrated in FIG. 1, the print head 1 at the time of printing is supported by, for example, a support member 2. It is installed in a production line in a state of being supported by the support member 2. The print head 1 installed in the production line is disposed such that the ejection port 10a faces the print surface of the printing material W from above. This place is an example of an installation place of the print head 1 when printing is performed by the ink jet recording apparatus I.

The print head 1 includes a mounting portion 9 detachably mounted to a support member 2 installed in a production line. The mounting portion 9 is provided on a back surface (rear surface) of the housing 10. The print head 1 is supported by the support member 2 via the mounting portion 9.

As illustrated in FIG. 3, the pressurizer 11 is disposed near an upper end of the housing 10 in the flight space S1. The pressurizer 11 is configured to be supplied with printing ink from the ink tank 106 of the controller 100 via the connection cable 1000. The ink pressurized by the pressurizer 11 is supplied to the print nozzle 12.

The print nozzle 12 is connected to a lower end portion of the pressurizer 11, and is disposed in an attitude in which an opening end (printing ink) thereof faces downward. The print nozzle 12 includes a piezoelectric element (for example, a piezo element) that applies vertical vibration to the ink, and applies the vertical vibration to the ink pressurized by the pressurizer 11 and then ejects the ink from the ejection port (opening end). Due to this vibration, the ink liquid ejected from the print nozzle 12 is formed into particles after a predetermined time from the ejection timing.

The printing ink ejected from the print nozzle 12 without being subjected to vibration (without being excited) flows in a so-called “ink shaft” having a shaft shape. On the other hand, the printing ink ejected from the print nozzle 12 that has been subjected to vibration (excited) has a shaft shape immediately after being ejected from the print nozzle 12, but becomes a particle shape as being separated from the print nozzle 12. The granulated printing ink drops as so-called “ink particles”. The printing ink passes through the charging electrode 13 regardless of whether it is an ink shaft or ink particles. Note that, by ejecting the solvent alone from the print nozzle 12, the solvent can flow in a shaft shape. Hereinafter, such a shaft-shaped solvent is also referred to as a “solvent shaft”. Central axes of the ink shaft and the solvent shaft are as indicated by a two-dot chain line Ax in FIG. 4A. The central axes Ax of the ink shaft and the solvent shaft extend so as to connect the print nozzle 12 and the gutter 16. The solvent supplied to clean the inside of the print head 1 passes through the pressurizer 11 and the print nozzle 12 in order, and is squirted from the tip portion of the print nozzle 12. The solvent squirted in this manner flows in a shaft shape along a flight axis Ax and passes through the charging electrode 13.

For example, a suction path 47 illustrated in FIG. 5 is connected to the print nozzle 12 as a return path for releasing the pressure inside the print head 1 when the ink jet recording apparatus I is stopped. The solvent can also be sucked from the print nozzle 12 through the suction path 47.

The charging electrode 13 includes a pair of metal plates having electrical conductivity, and is disposed below the print nozzle 12. Here, the pair of metal plates constituting the charging electrode 13 is fixed to the housing 10 in an attitude in which the longitudinal directions thereof are aligned with the upper-lower direction and in an attitude in which the metal plates face each other in the horizontal direction. The interval between the pair of metal plates is set to be larger than a particle diameter of the ink ejected from the print nozzle 12, and the printing ink ejected from the print nozzle 12 passes between the pair of metal plates.

A potential (positive potential) is applied to the charging electrode 13 at least when a printing operation is executed. Therefore, a potential difference is generated between the pressurizer 11 and the charging electrode 13, and the ink particles passing through the charging electrode 13 can be charged. In order to charge each ink particle, the charging electrode 13 according to the present embodiment is disposed in the vicinity of a breakpoint where the printing ink ejected from the print nozzle 12 is turned into particles. Note that the solvent ejected from the print nozzle 12 passes through the side of the charge detection sensor 14 and reaches the deflection electrode 15 without being charged.

The charge detection sensor 14 is disposed below the charging electrode 13. The charge detection sensor 14 is connected to a circuit board provided inside the housing 10. The charge detection sensor 14 can detect the charged state (in particular, a charge amount of each ink particle) of the ink particles passing through the side. A detection result by the charge detection sensor 14 is output to the control unit 101 as a detection signal. On the basis of this detection signal, the control unit 101 can determine whether or not each ink particle is appropriately charged.

The deflection electrode 15 includes a pair of metal plates (so-called “counter electrodes”) having electrical conductivity, and is disposed below the charging electrode 13 and the charge detection sensor 14. Here, the pair of metal plates are fixed to the housing 10 in an attitude in which the longitudinal directions thereof are substantially along the upper-lower direction and in an attitude in which the pair of metal plates face each other in the horizontal direction. The ink particles that have passed between the pair of metal plates constituting the charging electrode 13 pass between the pair of metal plates constituting the deflection electrode 15.

A voltage (hereinafter, this is also referred to as “deflection voltage”) that can be controlled by the controller 100 is applied to the deflection electrode 15. Therefore, a potential difference corresponding to the deflection voltage is generated between the pair of metal plates constituting the deflection electrode 15. Due to this potential difference, the flight direction of the ink particles can be deflected according to the charge amount of the ink particles. The flight direction of the ink particles can be deflected along an arrangement direction of the pair of metal plates constituting the deflection electrode 15.

The flight direction of the ink particles can be controlled via the deflection voltage applied to each of the charging electrode 13 and the deflection electrode 15. The ink particles whose flight direction is controlled in this manner include those deflected by the deflection electrode 15 and those not deflected by the deflection electrode 15 (those not deflected). Among them, the ink particles deflected by the deflection electrode 15 are involved in the printing of the printing material W. The ink particles deflected by the deflection electrode 15 are ejected from the ejection port 10a provided on the lower surface of the housing 10, and land on the printing material W.

On the other hand, the ink particles that are not deflected by the deflection electrode 15 are not involved in the printing of the printing material W. Such ink particles, or the shaft-shaped printing ink that is not formed into particles in the first place, reach the inside of the gutter 16 as exemplified by the chain line in FIG. 3. Similarly, the solvent used for cleaning the print nozzles 12 and the like in the print head 1 and having passed through the deflection electrode 15 also reaches the inside of the gutter 16.

The deflection electrode 15 includes a first electrode plate 151 and a second electrode plate 152 facing the first electrode plate 151. The first electrode plate 151 is grounded. A high voltage is applied to the second electrode plate 152.

The gutter 16 is formed of a curved pipe including an opening 16a facing upward, and is disposed below the deflection electrode 15. The gutter 16 according to the present embodiment can collect the printing ink that is not involved in printing of the printing material W and the solvent (specifically, the solvent ejected from the print nozzle 12) that has passed through the print nozzle 12.

The opening end of the print nozzle 12 is located directly above the opening 16a of the gutter 16. With this arrangement, the fluid flowing from the opening end of the print nozzle 12 along the vertical direction and the flying fluid can be received from the opening 16a of the gutter 16.

The gutter 16 is provided with a charge type or thermistor type gutter sensor 16b (see FIG. 2). The gutter sensor 16b can detect whether or not the printing ink is in the gutter 16, determine that the adjustment of the ink shaft is completed if the printing ink is in the gutter 16, and determine that the adjustment of the ink shaft is not completed if the printing ink is not in the gutter 16. The gutter sensor 16b is connected to the control unit 101 of the controller 100, and is configured to output a signal to the control unit 101.

The printing ink or solvent collected by the gutter 16 is sent back to the controller 100 through the connection cable 1000, the ink supply pipe 44, the solvent supply pipe 54, and the like, and stored in the ink tank 106. The ink or solvent thus collected is sent back to the controller 100 for reuse. By repeating such steps, the ink can be circulated.

The cleaning nozzle 17 is provided in the print head 1. The cleaning nozzle 17 functions as a so-called solvent injection unit. The cleaning nozzle 17 is a nozzle for ejecting or injecting a solvent to the print nozzle 12, the charging electrode 13, the deflection electrode 15, and the like in the print head 1 to clean them, and can squirt a solvent capable of dissolving ink. The solvent injected from the cleaning nozzle 17 is supplied from the solvent supply unit 105, for example, the solvent cartridge 51.

In the present embodiment, as exemplified by reference sign L1 in FIG. 4B, the solvent injected from the cleaning nozzle 17 is sprayed to a member such as the print nozzle 12, for example. Therefore, members such as the print nozzle 12 can be cleaned. For example, by cleaning the print nozzle 12, the solvent can be smoothly ejected from the print nozzle 12 at the time of head cleaning.

The shutter 21 opens and closes the ejection port 10a. The shutter 21 is electrically connected to the control unit 101 and opens and closes in response to a control signal from the control unit 101. By closing the ejection port 10a by the shutter 21, for example, it is possible to suppress solvent leakage from the ejection port 10a at the time of head cleaning.

The suction instrument 22 sucks air from the internal space of the print head 1, particularly the inside of the flight space, and discharges the air to the external space of the print head 1. The suction instrument 22 is electrically connected to the control unit 101 and operates in response to a control signal from the control unit 101. By operating the suction instrument 22, air in the internal space of the print head 1 can be sucked and exhausted.

The ink supply pipe 44 constitutes, for example, a path (first path R1) for feeding ink (ink before concentration adjustment) from the ink cartridge 41 to the ink tank 106. As illustrated in FIG. 5, the first path R1 includes a first ink pipe 44a as an ink circulating tube, a second ink pipe 44b, and a third ink pipe 44c. The first ink pipe 44a, the second ink pipe 44b, and the third ink pipe 44c are all disposed in the controller 100 in the present embodiment.

The first ink pipe 44a has one end portion connected to the ink hollow needle 43 and the other end portion (see a branch portion B1 in FIG. 5) branching into the second ink pipe 44b and the third ink pipe 44c. The first ink pipe 44a as an ink circulation tube connects the ink hollow needle 43 and the ink tank 106 via the second ink pipe 44b and the third ink pipe 44c, and circulates the ink from the ink hollow needle 43 to the ink tank 106. Note that, in the present embodiment, the ink is introduced into the ink tank 106 through the third ink pipe 44c, but may be introduced via, for example, the second ink pipe 44b. In this case, the ink is introduced into the ink tank 106 without passing through a viscometer 46.

The first pump P1 is disposed in the middle of the first ink pipe 44a. The first pump P1 is a suction pump for sucking so as to generate a flow from the ink hollow needle 43 toward the first ink pipe 44a.

An eighth valve V8 is disposed in the first ink pipe 44a between the reservoir 42 and the first pump P1. The eighth valve V8 is an on-off valve that opens and closes the flow path of the first ink pipe 44a.

The second ink pipe 44b connects the branch portion B1 of the first ink pipe 44a and the ink tank 106. The first valve V1 is disposed in the middle of the second ink pipe 44b. The first valve V1 is an on-off valve that opens and closes the flow path of the second ink pipe 44b.

The third ink pipe 44c connects the branch portion B1 of the first ink pipe 44a and the ink tank 106. An 11th valve V11 is disposed in the middle of the third ink pipe 44c. The 11th valve V11 is an on-off valve that opens and closes the flow path of the third ink pipe 44c.

The viscometer 46 is disposed in the third ink pipe 44c between the 11th valve V11 and the ink tank 106. The viscometer 46 detects the flow rate of the ink or the printing ink flowing through the third ink pipe 44c, and measures the viscosity on the basis of the flow rate. The viscometer 46 inputs a detection signal corresponding to the measurement result to the control unit 101.

The ink from the ink cartridge 41 sequentially passes through the ink hollow needle 43, the ink reservoir 42, the first ink pipe 44a, the second ink pipe 44b, and the third ink pipe 44c on the basis of the operation status of the first pump P1 and the opening and closing statuses of the first valve V1, the eighth valve V8, and the 11th valve V11, and is supplied to the ink tank 106.

The solvent supply pipe 54 constitutes a second path R2 for feeding the solvent from the solvent cartridge 51 to the ink tank 106 together with a part of the ink supply pipe 44.

As illustrated in FIG. 5, the second path R2 includes a first solvent pipe 54a, a second solvent pipe 54b, and a third solvent pipe 54c of the solvent supply pipe 54.

The first solvent pipe 54a includes one end portion connected to the solvent hollow needle 53 and the other end portion connected to the pressurizer 11 of the print head 1. A 28th valve V28, a second pump P2, a 16th valve V16, and a 12th valve V12 are disposed in this order from the upstream side to the downstream side in the middle of the first solvent pipe 54a in the solvent supply pipe 54. The second pump P2 is a suction pump for sucking so as to generate a flow from the solvent hollow needle 53 toward the solvent supply pipe 54.

The 28th valve V28, the 16th valve V16, and the 12th valve V12 are on-off valves that open and close the flow path of the first solvent pipe 54a. A portion between the 16th valve V16 and the 12th valve V12 of the first solvent pipe 54a is connected to the second solvent pipe 54b.

The second solvent pipe 54b connects the controller 100 and the print head 1 together with the solvent tube 1002. One end portion of the second solvent pipe 54b is connected to the cleaning nozzle 17. For example, by opening the 28th valve V28 and the 16th valve V16 and closing the 12th valve V12, the solvent can be supplied to the cleaning nozzle 17 via the first solvent pipe 54a and the second solvent pipe 54b.

The other end portion of the second solvent pipe 54b is connected to the connection portion B2 of the first ink pipe 44a. A 15th valve V15, a 27th valve V27, a conditioning tank 107, and a ninth valve V9 are disposed in the middle of the second solvent pipe 54b. The 15th valve V15, the 27th valve V27, and the ninth valve V9 are on-off valves that open and close the flow path of the second solvent pipe 54b, and among these, the 15th valve V15 is a valve that controls the supply of the solvent to the cleaning nozzle 17.

The third solvent pipe 54c includes one end portion connected to the connection portion B2 of the first ink pipe 44a and the other end portion connected to a portion between the 15th valve V15 and the 27th valve V27 in the second solvent pipe 54b. A 13th valve V13 is disposed in the middle of the third solvent pipe 54c. The 13th valve V13 is an on-off valve that opens and closes the flow path of the third solvent pipe 54c.

The ink supply pipe 44 also constitutes a path (third path R3) for circulating and stirring the stored object (printing ink) in the ink tank 106 in the controller 100. The third path R3 includes the fourth ink pipe 44d, the second ink pipe 44b, and the third ink pipe 44c of the ink supply pipe 44.

The fourth ink pipe 44d includes one end portion connected to the ink tank 106 and the other end portion connected to the connection portion B2 of the first ink pipe 44a. A fifth valve V5 is disposed in the middle of the fourth ink pipe 44d. The fifth valve V5 is an on-off valve that opens and closes the flow path of the fourth ink pipe 44d.

The printing ink in the ink tank 106 is sucked out by the fourth ink pipe 44d on the basis of the operation status of the first pump P1 and the opening and closing statuses of the first valve V1, the fifth valve V5, the ninth valve V9, and the 11th valve V11, and then sequentially passes through a part of the first ink pipe 44a (portion from the connection portion B2 to the branch portion B1 in FIG. 5), the second ink pipe 44b, and the third ink pipe 44c, and is sent back to the ink tank 106. Therefore, the printing ink circulates in the controller 100.

The ink supply pipe 44 further constitutes a fourth path R4 for feeding the printing ink from the ink tank 106 to the print nozzle 12 and feeding the printing ink back from the gutter 16 to the ink tank 106. The fourth path R4 includes the ink supply pipe 44 and the ink tube 1001 of the connection cable 1000.

The fourth path R4 includes the ink tube 1001, and the sixth ink pipe 44f and the seventh ink pipe 44g of the ink supply pipe 44. Both the sixth ink pipe 44f and the seventh ink pipe 44g connect the controller 100 and the print head 1 together with the ink tube 1001.

The sixth ink pipe 44f includes one end portion connected to the ink tank 106 and the other end portion connected to the print nozzle 12 via the ink tube 1001. The third pump P3 and the 26th valve V26 are disposed in the middle of the sixth ink pipe 44f. The third pump P3 is a suction pump for sucking so as to generate a flow from the ink tank 106 toward the sixth ink pipe 44f. The 26th valve V26 is an on-off valve that opens and closes the flow path of the sixth ink pipe 44f.

A 14th valve V14 is disposed in the sixth ink pipe 44f between the third pump P3 and the print nozzle 12. The 14th valve V14 is an on-off valve that opens and closes the flow path of the sixth ink pipe 44f.

The seventh ink pipe 44g includes one end portion connected to the gutter 16 via the ink tube 1001 and the other end portion connected to the ink tank 106 via the sixth ink pipe 44f. The fourth pump P4 and the 24th valve V24 are disposed in the middle of the seventh ink pipe 44g. The fourth pump P4 is a suction pump for sucking so as to generate a flow from the gutter 16 toward the seventh ink pipe 44g. The 24th valve V24 is an on-off valve that opens and closes the flow path of the seventh ink pipe 44g. The other end portion of the seventh ink pipe 44g is connected to a portion of the sixth ink pipe 44f between the 26th valve V26 and the third pump P3.

The printing ink in the ink tank 106 is sucked out by the sixth ink pipe 44f according to the operation status of the third pump P3 and the opening and closing status of the 26th valve V26, and ejected from the print nozzle 12. The printing ink ejected from the print nozzle 12 lands on the surface of the printing material W during printing, and is collected by the gutter 16 during non-printing. The latter printing ink is sucked out by the seventh ink pipe 44g according to the operation status of the fourth pump P4 and the opening and closing status of the 24th valve V24, and sent back to the ink tank 106. Therefore, the printing ink circulates between the controller 100 and the print head 1.

The solvent supply pipe 54 constitutes a fifth path R5 for feeding a cleaning solvent from the solvent cartridge 51 to the print nozzle 12 together with a part element of the ink supply pipe 44. The fifth path R5 includes the ink supply pipe 44 and the solvent tube 1002 of the connection cable 1000.

As illustrated in FIG. 5, the fifth path R5 includes the solvent tube 1002 and the first solvent pipe 54a in the solvent supply pipe 54.

The solvent from the solvent cartridge 51 passes through the solvent hollow needle 53 and the solvent reservoir 52 according to the operation status of the second pump P2 and the opening and closing statuses of the 28th valve V28, the 16th valve V16, and the 12th valve V12, and is supplied to a middle portion of the sixth ink pipe 44f (a portion between the 14th valve V14 and the print nozzle 12). The solvent supplied to this portion is ejected from the print nozzle 12. This solvent cleans the print head 1.

Since the cleaning nozzle 17 is connected to the second solvent pipe 54b, a solvent as a cleaning liquid can be ejected or injected from the cleaning nozzle 17. On the way from the cleaning nozzle 17 to the second solvent pipe 54b, a 15th valve V15 for controlling the supply of the solvent to the cleaning nozzle 17 is provided.

The controller 100 includes a suction path 47 connected to the print nozzle 12 as a path related to suction of ink. The suction path 47 is provided with a sixth valve V6. For example, at the time of non-printing, by activating the first pump P1 in a state where the sixth valve V6 is opened, the ink can be sucked via the suction path 47 and the sucked ink can be sent back to the controller 100.

### Air injection module

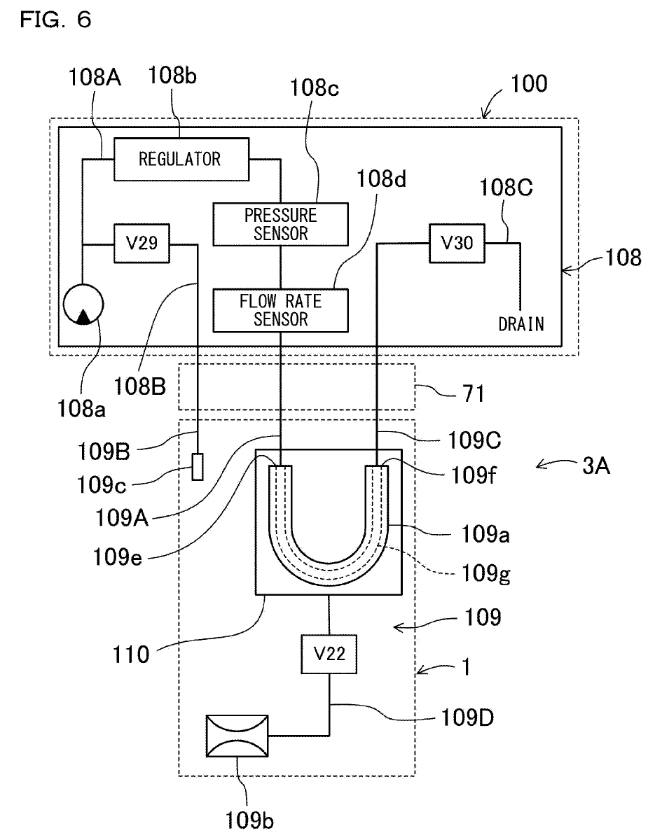

The ink jet recording apparatus I according to the present embodiment includes an air injection module 3A that supplies high-pressure air into the print head 1 as an element related to the cleaning processing in the print head 1. As illustrated in FIG. 6, the air injection module 3A includes a controller-side module 108 provided in the controller 100 and a head-side module 109 provided in the print head 1.

The controller-side module 108 includes an air pump 108a, a regulator 108b, a pressure sensor 108c, a flow rate sensor 108d, a 29th valve V29, and a 30th valve V30. The controller-side module 108 further includes, as piping elements, a first air feeding pipe 108A, a second air feeding pipe 108B, and a drain piping 108C. The 29th valve V29 and the 30th valve V30 are on-off valves (electromagnetic valves) controlled by the controller 100.

The air pump 108a is an example of an air generation unit included in the controller 100. The air pump 108a is, for example, a diaphragm type air pump. The air pump 108a is electrically connected to the control unit 101, and operates in response to a control signal from the control unit 101.

An upstream end of the first air feeding pipe 108A is connected to an ejection port of the air pump 108a. The downstream end of the first air feeding pipe 108A is connected to the head-side module 109 via an umbilical cable 71 included in the connection cable 1000. In the first air feeding pipe 108A, a regulator 108b, a pressure sensor 108c, and a flow rate sensor 108d are disposed in this order from the upstream side to the downstream side.

The regulator 108b adjusts the pressure of the high-pressure air ejected from the air pump 108a to flow to the downstream side of the first air feeding pipe 108A, and includes a pressure adjustment valve and the like. The regulator 108b is an example of an air pressure regulation unit that is included in the controller 100 and adjusts the pressure of the high-pressure air generated by the air pump 108a.

The air whose pressure is adjusted by the regulator 108b is an example of high-pressure air. The high-pressure air is not particularly limited as long as it has a pressure higher than the atmospheric pressure. For example, the high-pressure air is an air of 100 kPa or more and 300 kPa, more specifically, an air of 150 kPa or more and 250 kPa or less. As an example, in the present embodiment, high-pressure air of slightly less than 200 kPa flows to the downstream side of the first air feeding pipe 108A.

The pressure sensor 108c detects a pressure state of the high-pressure air regulated by the regulator 108b. The flow rate sensor 108d detects the flow rate of the high-pressure air regulated by the regulator 108b. Each of the pressure sensor 108c and the flow rate sensor 108d is electrically connected to the control unit 101, and inputs a detection signal thereof to the controller 100.

The upstream end of the second air feeding pipe 108B is connected to a portion of the first air feeding pipe 108A between the air pump 108a and the regulator 108b. The downstream end of the second air feeding pipe 108B is connected to the head-side module 109 via the umbilical cable 71 included in the connection cable 1000. The 29th valve V29 is disposed in the middle of the second air feeding pipe 108B. The 29th valve V29 is an on-off valve (electromagnetic valve) that opens and closes the flow path of the second air feeding pipe 108B.

Although described in detail later, the drain piping 108C is a member for draining condensed water included in high-pressure air, and the drain piping 108C constitutes a drain passage. The upstream end of the drain piping 108C is connected to the head-side module 109 via the umbilical cable 71. The downstream end of the drain piping 108C is disposed on the side of the controller 100, and the condensed water of the head-side module 109 is discharged to the side of the controller 100. The 30th valve V30 is disposed in the middle of the drain piping 108C. The 30th valve V30 is a drain on-off valve (electromagnetic valve) that opens and closes a flow path (drain passage) of the drain piping 108C.

The head-side module 109 includes a first air receiving piping 109A, a second air receiving piping 109B, a drain pipe 109C, and a high-pressure air supply pipe 109D as piping elements. Each of the first air receiving piping 109A and the second air receiving piping 109B is an example of an air receiving unit that receives high-pressure air.

The head-side module 109 further includes a removal unit 109a that removes condensed water contained in the high-pressure air received by the first air receiving piping 109A, an air injection unit 109b, a dry air opening 109c, and a 22nd valve V22.

The upstream end of the first air receiving piping 109A is connected to the downstream end of the first air feeding pipe 108A via the umbilical cable 71. That is, the first air receiving piping 109A receives the high-pressure air generated by the controller 100 via the connection cable 1000 that fluidly and electrically connects the print head 1 and the controller 100. The downstream end of the first air receiving piping 109A is connected to an air inlet 109e of the removal unit 109a. Therefore, the high-pressure air generated by the air pump 108a flows into the air inlet 109e of the removal unit 109a via the first air feeding pipe 108A and the first air receiving piping 109A.

Condensed water may be included in the high-pressure air compressed by the air pump 108a. A portion for removing the condensed water is the removal unit 109a, and the removal unit 109a is formed of a member capable of removing the condensed water included in the high-pressure air received by the first air receiving piping 109A. The removal unit 109a of the present embodiment is a member that removes the condensed water included in the high-pressure air by pressurizing the high-pressure air received by the first air receiving piping 109A. More specifically, the removal unit 109a includes a water-repellent air flow path 109g including fine pores, pressurizes the high-pressure air flowing through the water-repellent air flow path 109g, and takes out the high-pressure air in the water-repellent air flow path 109g via the fine pores while keeping the condensed water in the water-repellent air flow path 109g.

The water-repellent air flow path 109g is curved so as to protrude downward. This makes it possible to accumulate the condensed water in the middle of the water-repellent air flow path 109g by utilizing gravity. That is, if the condensed water accumulates in the entire flow direction of the water-repellent air flow path 109g, the condensed water becomes an obstacle and the high-pressure air cannot be taken out from the water-repellent air flow path 109g, so that the flow path shape is such that the condensed water can be accumulated only in a part of the flow direction of the water-repellent air flow path 109g. Such a flow path shape may be, for example, a shape curved in an S shape other than a shape (U shape) curved so as to protrude downward.

The water-repellent air flow path 109g according to the present embodiment is formed of a porous tube including a plurality of fine pores capable of ventilation. This makes it possible to take out the high-pressure air via the plurality of fine pores of the porous tube. Note that the water-repellent air flow path 109g is not limited to the porous tube, and may be, for example, a porous sheet including a plurality of fine pores. That is, the member constituting the water-repellent air flow path 109g may be any member having water repellency and fine pores, and is not particularly limited. The porous tube or the porous sheet is made of, for example, polytetrafluoroethylene (PTFE).

With such a configuration, the entire removal unit 109a is accommodated in an airtight compartment 110. The high-pressure air flowing out from the fine pores of the removal unit 109a flows out only into the airtight compartment 110.

An upstream end of the high-pressure air supply pipe 109D is connected to the airtight compartment 110. The air injection unit 109b that injects the high-pressure air from which the condensed water has been removed by the removal unit 109a is connected to a downstream end of the high-pressure air supply pipe 109D. The air injection unit 109b is, for example, an air nozzle. The 22nd valve V22 including an electromagnetic valve that controls the flow rate of the high-pressure air is disposed in the middle of the high-pressure air supply pipe 109D. The 22nd valve V22 is an electromagnetic valve disposed in the middle of the air path from the air pump 108a to the air injection unit 109b. The 22nd valve V22 is controlled by the controller 100, and high-pressure air is injected from the air injection unit 109b by opening and closing control of the 22nd valve V22.

An upstream end of the drain pipe 109C is connected to a condensed water flow outlet 109f of the removal unit 109a. The downstream end of the drain pipe 109C is connected to the upstream end of the drain piping 108C via the umbilical cable 71. That is, the drain piping 108C is provided on the downstream side of the water-repellent air flow path 109g and constitutes a drain passage for discharging the condensed water accumulated in the water-repellent air flow path 109g.

With the above configuration, it is possible to remove the condensed water contained in the high-pressure air received by the first air receiving piping 109A, but it is also possible to remove the condensed water with a structure other than the above-described structure. For example, the condensed water may be removed by heating the high-pressure air received by the first air receiving piping 109A. In this case, a heater (removal unit) that heats the high-pressure air received by the first air receiving piping 109A is provided in the print head 1. The controller 100 activates the heater at a predetermined timing to heat the high-pressure air and remove the condensed water.

Furthermore, the removal unit may have an air flow path including a moisture absorbing material. In this case, the condensed water is removed by allowing the high-pressure air received by the first air receiving piping 109A to flow through the air flow path. That is, when the condensed water is included in the high-pressure air flowing through the air flow path, the condensed water is absorbed by the moisture absorbing material. The moisture absorbing material may be dried by a heater or the like at a predetermined timing.

The downstream end of the second air receiving piping 109B is connected to the upstream end of the second air feeding pipe 108B via the umbilical cable 71. The dry air opening 109c for supplying air having a pressure lower than that of the high-pressure air into the print head 1 is connected to a downstream end of the second air receiving piping 109B. That is, the print head 1 includes the dry air opening 109c for supplying low-pressure air into the print head 1. When the 29th valve V29 is opened in a state where the air pump 108a is activated, the low-pressure air is supplied from the dry air opening 109c.

As illustrated in FIGS. 4A and 4B, the air injection unit 109b is disposed on the first electrode plate 151 so as to inject air toward the second electrode plate 152. The air injection unit 109b is embedded in the first electrode plate 151 and open on a surface facing the second electrode plate 152. The opening of the air injection unit 109b faces the second electrode plate 152.

An injection axis Aa of the air in the air injection unit 109b extends toward the second electrode plate 152 of the deflection electrode 15 as illustrated in FIG. 4A. In other words, the injection axis Aa of the high-pressure air intersects with the second electrode plate 152 as illustrated in FIG. 4A.

Note that the “injection axis Aa of air” as used herein refers to the central axis of the high-pressure air injected from the air injection unit 109b. That is, the fact that the injection axis Aa of the high-pressure air extends toward the second electrode plate 152 indicates that the air injection unit 109b according to the present embodiment injects the high-pressure air toward the deflection electrode 15, particularly toward the second electrode plate 152.

The injection axis Aa of the high-pressure air in the air injection unit 109b intersects with the flight axis Ax as illustrated in FIG. 4A. That is, the air injection unit 109b according to the present embodiment is disposed so that the flight axis Ax of the solvent squirted from the print nozzle 12 is interposed between the air injection unit 109b and the deflection electrode 15, particularly, the second electrode plate 152.

At the time of head cleaning, the control unit 101 activates the air pump 108a in a state where the 22nd valve V22, the 30th valve V30, and the 29th valve V29 are closed. Therefore, the air pressure can be increased. When the 22nd valve V22 is opened in a state where the pressure of the air is increased, the high-pressure air is injected from the air injection unit 109b.

Here, as illustrated by reference sign M1 in FIG. 4B, the air injection unit 109b intersects the high-pressure air with the flight axis Ax of the solvent ejected or injected in the print head 1. The air injection unit 109b diffuses the solvent into the print head 1 by crossing the high-pressure air with respect to the flight axis Ax. Specifically, in the example illustrated in FIGS. 4A and 4B, the flight axis Ax of the solvent ejected or squirted from the print nozzle 12 is interposed between the air injection unit 109b and the second electrode plate 152, and the flight axis Ax and the injection axis Aa of the air intersect with each other. Therefore, the high-pressure air (indicated by reference sign M1 in FIG. 4B) ejected along the injection axis Aa can be applied to the shaft-shaped solvent squirted along the flight axis Ax from the print nozzle 12 or the droplet-like solvent squirted from the print nozzle 12.

The air injection unit 109b can also atomize a solvent by applying high-pressure air to a shaft-shaped solvent. Specifically, the air injection unit 109b brings the injected high-pressure air into contact with the solvent supplied from the solvent supply unit 105, thereby atomizing the solvent as indicated by reference sign M1 in FIG. 4B.

The atomization of the solvent by the air injection module 3A is realized by increasing the pressure of the air. Furthermore, the high-pressure air hits the solvent squirted along the flight axis Ax and then collides with the second electrode plate 152. By causing air to collide with the second electrode plate 152, dirt adhering to the second electrode plate 152 is easily removed. Furthermore, by atomizing the solvent, the cleaning area of the part by the solvent is enlarged as compared with the case where the solvent is not atomized. By applying the solvent atomized by collision with the high-pressure air to the second electrode plate 152, the second electrode plate 152 and each component disposed around the second electrode plate 152, that is, each component in the print head 1, can be cleaned. The cleaning with the solvent is particularly effective for dirt caused by ink, for example.

Whether or not the solvent can be atomized as intended depends on the outflow state of the high-pressure air flowing out in the print head 1. Therefore, in the present embodiment, an outflow state of the high-pressure air flowing out in the print head 1 can be detected. The ink jet recording apparatus I includes a pressure sensor 108c and a flow rate sensor 108d that function as an air outflow state detection unit that detects the outflow state of high-pressure air flowing out in the print head 1. Since the pressure sensor 108c and the flow rate sensor 108d are provided in the controller 100, they detect the outflow state of the high-pressure air before being injected by the air injection unit 109b. More specifically, since the pressure sensor 108c and the flow rate sensor 108d are disposed on the downstream side of the regulator 108b, the state of the high-pressure air regulated by the regulator 108b is detected as the outflow state of the high-pressure air.

That is, the pressure sensor 108c detects the pressure state of the high-pressure air regulated by the regulator 108b as the outflow state of the high-pressure air. Furthermore, the flow rate sensor 108d detects the flow rate of the high-pressure air regulated by the regulator 108b as the outflow state of the high-pressure air.

In this embodiment, since the 22nd valve V22 is provided between the air pump 108a and the air injection unit 109b, the 22nd valve V22 is brought into a closed state to increase the pressure between the air pump 108a and the 22nd valve V22 when the flow rate sensor 108d detects the flow rate of the high-pressure air. The 22nd valve V22 may be provided on the side of the print head 1 or may be provided on the side of the controller 100. However, in consideration of the flow path resistance from the controller 100 to the print head 1, it may be preferable that the 22nd valve V22 is provided in the vicinity of the air injection unit 109b. That is, when the 22nd valve V22 is opened after the pressure is stored in the path itself between the air pump 108a and the air injection unit 109b, the force immediately after the opening of the 22nd valve V22 can be effectively used.

In the process in which the 22nd valve V22 is closed to open, the pressure state of the high-pressure air can be detected by the pressure sensor 108c. First, if the pressure is low when the air pump 108a is activated with the 22nd valve V22 in the closed state, the path to the air pump 108a or the pressure sensor 108c may be blocked. Furthermore, if the pressure is too high when the 22nd valve V22 is in the open state, the air injection unit 109b may be narrowed.

Furthermore, when the flow rate sensor 108d detects a flow rate more than or equal to a certain level when the 22nd valve V22 is in the closed state, the 22nd valve V22 and other paths may not be closed, and leakage may occur. If the flow rate sensor 108d does not detect a certain flow rate or more when the 22nd valve V22 is in an open state, the air injection unit 109b may be narrowed.

As described above, the pressure sensor 108c detects a pressure state of the high-pressure air when the 22nd valve V22 is in an open state and a pressure state of the high-pressure air when it is in a closed state. Furthermore, the flow rate sensor 108d detects the flow rate of the high-pressure air when the 22nd valve V22 is in an open state and the flow rate of the high-pressure air when the 22nd valve V22 is in a closed state. Therefore, the control unit 101 can determine whether or not the air injection unit 109b is narrowed. When it is determined that there is a possibility of narrowing of the air injection unit 109b or when it is determined that the ejection amount of the air pump 108a is abnormal, the control unit 101 displays error information on the display unit 103a or the like so as not to perform the cleaning operation using the high-pressure air.

The control unit 101 includes the cleaning control unit 101a as a functional element for controlling head cleaning by the solvent supply unit 105 and the air injection module 3A. By the control performed by the cleaning control unit 101a, at least one of the timing at which the solvent supply unit 105 ejects or injects the solvent in the print head 1 and the timing at which the air injection module 3A intersects the flight axis Ax with the high-pressure air is adjusted. With this adjustment, the air injection module 3A intersects the high-pressure air with the flight axis Ax. Specifically, under the control of the cleaning control unit 101a, both the timing at which the solvent supply unit 105 ejects or injects the solvent in the print head 1 and the timing at which the air injection module 3A intersects the flight axis Ax with the high-pressure air are adjusted.

Here, the cleaning control unit 101a can control the timing of ejecting or injecting the solvent in the print head 1 via the valve opening timing of the 12th valve V12 as a solvent control valve. The cleaning control unit 101a can also adjust the timing at which the high-pressure air intersects the flight axis Ax via the valve opening timing of the 22nd valve V22.

The cleaning control unit 101a can also activate the shutter 21 to close the ejection port 10a when injecting the high-pressure air. This suppresses solvent leakage from the print head 1, particularly its housing 10.

Furthermore, when the ejection port 10a is closed by the shutter 21, the cleaning control unit 101a activates the suction instrument 22 to suck and exhaust air from the inside of the print head 1. Therefore, the inside of the print head 1 is dried, and the solvent adhering to the inside of the print head 1 volatilizes. As a result, solvent leakage from the print head 1, particularly the housing 10 thereof, is suppressed.

As illustrated in FIG. 2, the controller 100 includes an error detection unit 101b. The error detection unit 101b detects an error related to ink contamination of at least one of the print nozzle 12, the charging electrode 13, the deflection electrode 15, and the gutter 16 provided in the print head 1. The error detection unit 101b detects at least one of a clogging error of the print nozzle 12, an error of the deflection electrode 15, a contamination error in the print head 1, and an error of the charging electrode 13 as an error related to ink contamination. Note that it is not essential to notify the user of the detected error, but for example, by notifying the user of the detected error by the display unit 103a, the user can grasp the error state of the device.

For example, as an error of the deflection electrode 15, there is an error in which the deflection electrode 15 is short-circuited due to ink contamination and the voltage drops. For example, the error detection unit 101b acquires the voltage of the deflection electrode 15, whereby the error of the deflection electrode 15 can be detected. Furthermore, for the charging electrode 13, an error of the charging electrode 13 can be detected by the error detection unit 101b acquiring a detection value of the charge detection sensor 14.

There are various methods for error detection by the error detection unit 101b. For example, when the ink adheres to the deflection electrode 15 and the adhered ink greatly grows, the voltage may decrease. Then, the ink particles are not normally deflected, and the printing is disturbed. At this time, an error of the deflection electrode 15 occurs. When the error of the deflection electrode 15 repeatedly occurs, a “print head contamination error” may occur.

Furthermore, the charge amount of the negatively charged ink particles is measured by the charge detection sensor 14 located immediately after the print nozzle 12. At this time, if the charge detection sensor 14 is contaminated, the charge amount cannot be measured, and a “charge sensor contamination error” occurs. As a result, when phase matching is not performed normally, a “phase matching error” occurs. Since both the deflection electrode 15 and the charge detection sensor 14 are provided in the print head 1, these errors are considered to have originated from the print head 1, and are classified as errors originating from the print head 1.

An error in which a factor may be the print head 1 or otherwise can also be detected by the error detection unit 101b. For example, whether the ink is normally collected in the gutter 16 can be monitored by the gutter sensor 16b disposed around the gutter 16. That is, the error detection unit 101b can acquire the detection result of the gutter sensor 16b, and determine whether the ink is normally collected in the gutter 16 on the basis of the acquired result. In a case where the ink is not collected in the gutter 16, a “nozzle clogging error” occurs during the start-up by a start-up processing execution unit 101f of the ink jet recording apparatus I, and a “gutter sensor non-detection error” occurs after the ink jet recording apparatus I is once started up by the start-up processing execution unit 101f. The start-up processing execution unit 101f is a portion that executes start-up processing of collecting the ink ejected from the print nozzle 12 in the gutter 16 and circulating the ink.

As a factor of not collecting the ink in the gutter 16, clogging of the print nozzle 12, a failure in normal movement of the first pump P1 and the fourth pump P4, and the like can be cited. The clogging error of the print nozzles 12 is an error due to the print head 1, and the error in which the pumps P1 and P4 are not normally moving is an error due to something other than the print head 1 (the controller 100). It is not possible to identify whether the factor of these errors is in the print head 1 or otherwise. Thus, these errors are classified as errors in which a factor may be the print head 1 or otherwise.

An error in which the factor is limited to something other than the print head 1 can also be detected by the error detection unit 101b. Examples of the error in which the factor is limited to something other than the print head 1 include an error in a case where the ink pressure is low and an error in a case where the ink pressure is high. These errors occur when a value of a pressure gauge 49 (illustrated in FIG. 2) disposed in the ink supply pipe 44 becomes abnormal in the start-up state of the ink jet recording apparatus I. The pressure gauge 49 can be provided, for example, in the sixth ink pipe 44f of the ink supply pipe 44.

Normally, in the start-up state of the ink jet recording apparatus I, the ink pressure in the ink supply pipe 44 is adjusted to a predetermined range in order to maintain normal ejection from the print nozzle 12. However, for example, the ink pressure in the ink supply pipe 44 may greatly deviate from the predetermined range due to the influence of a pressure reducing valve defect or the like. For example, since the pressure reducing valve is present other than the print head 1, such an error is classified as an error in which the factor is limited to something other than the print head 1.

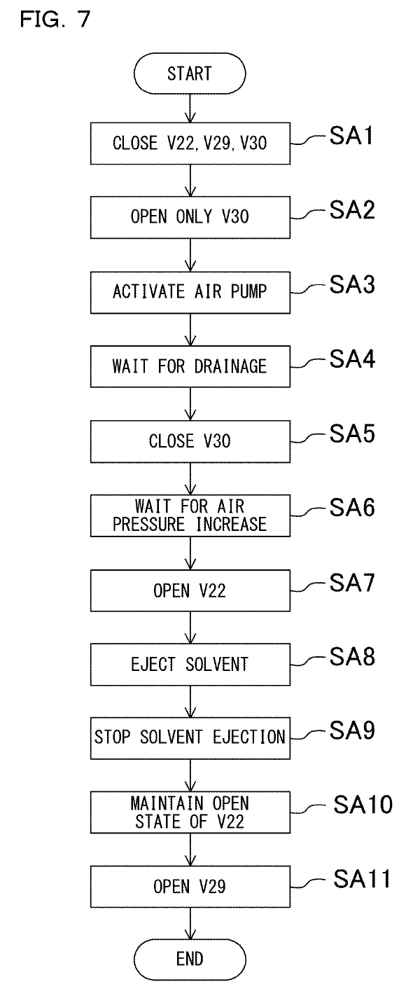

The operation at the time of cleaning using the high-pressure air will be described on the basis of the flowchart illustrated in FIG. 7. The operation during cleaning using high-pressure air is referred to as a basic cleaning operation. The basic cleaning operation may be periodically executed, may be executed when the above-described error occurs, or may be executed when a cleaning execution instruction is received from the user. In step SA1 after the start, the cleaning control unit 101a brings all of the 22nd valve V22, the 29th valve V29, and the 30th valve V30 into a closed state.

In step SA2, the cleaning control unit 101a brings only the 30th valve V30 into an open state and maintains the closed states of the 22nd valve V22 and the 29th valve V29. In step SA3, the cleaning control unit 101a activates the air pump 108a. The high-pressure air ejected from the air pump 108a flows into the removal unit 109a through the first air feeding pipe 108A and the first air receiving piping 109A. At this time, when the condensed water is accumulated in the water-repellent air flow path 109g of the removal unit 109a, the condensed water is pushed out from the condensed water flow outlet 109f by the high-pressure air flowing into the removal unit 109a and flows into the drain pipe 109C. Since the 30th valve V30 is in the open state, the condensed water flowing into the drain pipe 109C flows to the side of the controller 100 and is drained from the drain piping 108C.

The drainage processing of the condensed water is processing of draining the condensed water accumulated in the water-repellent air flow path 109g from the drain passage by bringing the 30th valve V30 into an open state and introducing high-pressure air from the upstream side of the water-repellent air flow path 109g at a predetermined condensed water drainage timing, and is executed by the cleaning control unit 101a. The drainage processing of the condensed water is processing executed before the basic cleaning operation. The drainage processing of the condensed water may be necessarily executed before the basic cleaning operation, or for example, the drainage processing of the condensed water may be executed only before one basic cleaning operation among a plurality of times of the basic cleaning operations.

In step SA4, the activation of the air pump 108a is continued until the above-described drainage of the condensed water is performed. In step SA5, the cleaning control unit 101a brings the 30th valve V30 into a closed state when it is estimated that the drainage of the condensed water has been completed.

In step SA6, while the activation of the air pump 108a is continued, it waits for the air pressure in the first air feeding pipe 108A and the first air receiving piping 109A to increase. The waiting time may be a uniformly determined time or a time until the pressure value measured by the pressure sensor 108c becomes more than or equal to a predetermined value.

When the air pressure in the first air feeding pipe 108A and the first air receiving piping 109A increases, the process proceeds to step SA7, and the cleaning control unit 101a brings only the 22nd valve V22 into an open state. Therefore, the high-pressure air is injected from the air injection unit 109b.

In step SA8, as described above, the cleaning control unit 101a causes the print nozzle 12 to eject the solvent alone in a shaft shape. The solvent ejected in a shaft shape is atomized by high-pressure air and used for cleaning the deflection electrode 15 and the like. When the predetermined cleaning time has elapsed, the process proceeds to step SA9, and the solvent ejection from the print nozzle 12 is stopped. In step SA10, the cleaning control unit 101a maintains the open state of the 22nd valve V22. Therefore, since the high-pressure air continues to be supplied to the deflection electrode 15 and the like, the drying time of the solvent adhering to the deflection electrode 15 and the like is shortened.

In step SA11, the cleaning control unit 101a brings the 29th valve V29 into an open state. Therefore, the air ejected from the air pump 108a is supplied from the dry air opening 109c to the inside of the print head 1, so that the drying time of the solvent adhering to the deflection electrode 15 and the like is further shortened. Note that the solvent ejection stop in step SA9, and step SA11 may be executed simultaneously, or step SA11 may be started before the solvent ejection stop in step SA9.

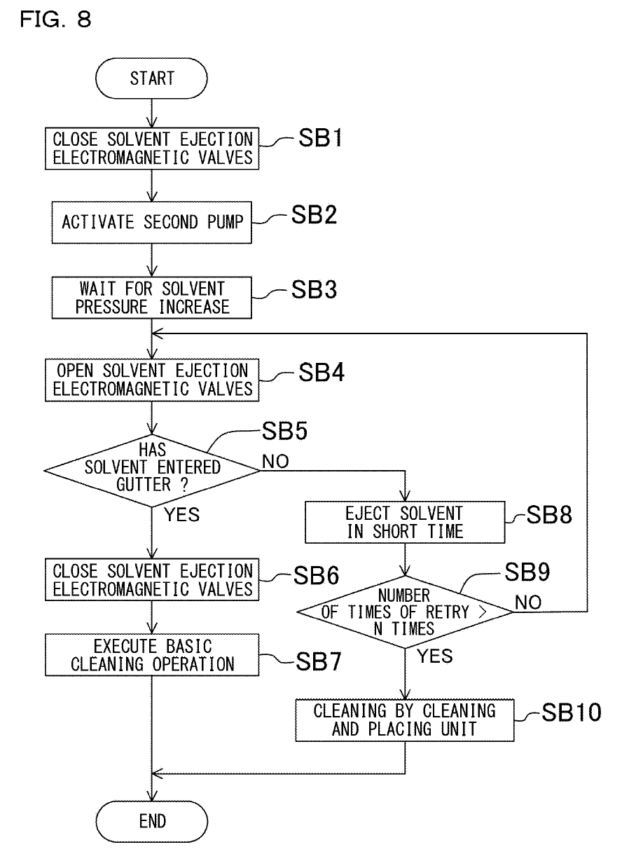

FIG. 8 is a flowchart illustrating an operation at the time of cleaning without using high-pressure air. The operation at the time of cleaning without using the high-pressure air may be periodically performed, may be performed when an error having a factor in the print head 1 among the above-described errors occurs, or may be performed when a cleaning execution instruction from the user is received. In step SB1 after the start, the cleaning control unit 101a brings all of the solvent ejection electromagnetic valves including the 28th valve V28, the 16th valve V16, and the 12th valve V12 into a closed state. In step SB2, the cleaning control unit 101a activates the second pump P2.

In step SB3, it waits for the solvent pressure in the solvent supply pipe 54 to increase. The waiting time may be a uniformly determined time or a time until the pressure value in the solvent supply pipe 54 becomes more than or equal to a predetermined value.

In step SB4, the cleaning control unit 101a brings the solvent ejection electromagnetic valves into an open state. In step SB5, the cleaning control unit 101a determines whether or not the solvent has entered the gutter 16 on the basis of a signal output from the gutter sensor 16b. In a case where the solvent has entered the gutter 16, since the solvent is ejected from the print nozzle 12, it can be determined that the print nozzle 12 is normal. In a case where YES is determined in step SB5, the process proceeds to step SB6 to bring the solvent ejection electromagnetic valves into a closed state. Then, in step SB7, the basic cleaning operation illustrated in the flowchart of FIG. 7 is executed.

On the other hand, in a case where NO is determined in step SB5 and the solvent has not entered the gutter 16, for example, it can be determined that the print nozzle 12 is clogged. In this case, the process proceeds to step SB8, where the cleaning control unit 101a brings the 15th valve V15 into an open state and ejects the solvent from the cleaning nozzle 17 for a short time (for example, several seconds). The solvent ejected from the cleaning nozzle 17 adheres to the print nozzle 12 to eliminate clogging of the print nozzle 12. Since the clogging of the print nozzle 12 may not be resolved by ejecting the solvent from the cleaning nozzle 17 only once, in step SB8, it is determined whether or not the short-time ejection of the solvent from the cleaning nozzle 17 has been performed more than N times, that is, the number of times of retry > N times. In a case where NO is determined, the process proceeds to step SB4. On the other hand, in a case where YES is determined, the process proceeds to step SB10, and the cleaning by the cleaning and placing unit 200 is executed.

That is, as illustrated in FIG. 1, the ink jet recording apparatus I includes the cleaning and placing unit 200. The cleaning and placing unit 200 is disposed at a place different from an installation place of the print head 1 (an installation place of the print head 1 installed in the production line) when printing is performed by the ink jet recording apparatus I.

The cleaning and placing unit 200 is configured such that the print head 1 is placed when the print head 1 is cleaned using a solvent. The cleaning and placing unit 200 and the print head 1 are communicably connected. Furthermore, the print head 1 and the controller 100 are communicably connected. When the print head 1 is placed on the cleaning and placing unit 200, a solvent is ejected from a solvent nozzle (not illustrated) provided in the cleaning and placing unit 200. The solvent ejected from the solvent nozzle of the cleaning and placing unit 200 hits the deflection electrode 15 and the like of the print head 1. This enables cleaning of the print head 1 using the cleaning and placing unit 200. The solvent received by the cleaning and placing unit 200 is sent to the controller 100.

The cleaning control unit 101a executes a plurality of cleaning operations including the basic cleaning operation using high-pressure air illustrated in FIG. 7 and the cleaning operation not using high-pressure air illustrated in FIG. 8. That is, the cleaning control unit 101a can execute the basic cleaning operation using high-pressure air and the cleaning operation not using high-pressure air as a plurality of different in-line cleaning operations for cleaning the print head 1 by supplying a solvent to the print head 1 via the connection cable 1000 in a state where the print head 1 is installed in a production line. Then, the cleaning control unit 101a executes at least one in-line cleaning operation according to the type of error detected by the error detection unit 101b between the basic cleaning operation using the high-pressure air and the cleaning operation not using the high-pressure air.

For example, when at least one of an error of the deflection electrode 15, a contamination error in the print head 1, and an error of the charging electrode 13 is detected by the error detection unit 101b, the cleaning control unit 101a cleans the print head 1 by atomizing the solvent supplied into the print head 1 with the high-pressure air injected from the air injection unit 109b. On the other hand, when a clogging error of the print nozzle 12 is detected by the error detection unit 101b, the cleaning control unit 101a cleans the print head 1 with the solvent ejected from the cleaning nozzle 17.

Specifically, according to the type of error detected by the error detection unit 101b, the cleaning control unit 101a selects one of the operation of cleaning the print head 1 by atomizing the solvent supplied into the print head 1 by the high-pressure air injected from the air injection unit 109b as illustrated in FIG. 7 and the operation of cleaning the print head 1 by the solvent ejected from the cleaning nozzle 17 as illustrated in FIG. 8, and executes the selected cleaning operation.

When the solvent is atomized at the time of the in-line cleaning operation, the cleaning control unit 101a supplies the solvent into the print head 1 in a shaft shape and applies high-pressure air to the shaft-shaped solvent to atomize the solvent, so that the solvent can be sufficiently attached to surrounding components to enhance the cleaning effect. On the other hand, since the solvent ejected from the cleaning nozzle 17 can be applied to the print head 1 at the time of the in-line cleaning operation, the amount of the solvent to be supplied to the print head 1 can be sufficiently secured. Furthermore, the cleaning control unit 101a can also clean the print head 1 by circulating a solvent through the ink path in the print head 1 without using high-pressure air according to the type of error detected by the error detection unit 101b.

The controller 100 includes a cleaning management unit 101d (see FIG. 2) that manages a usage amount of the solvent supplied at the time of the in-line cleaning operation by the cleaning control unit 101a. The cleaning management unit 101d manages the amount of solvent used at the time of head cleaning so that an amount of solvent corresponding to the high-pressure air injected from the air injection unit 109b is supplied. That is, the cleaning management unit 101d manages the amount of solvent used at the time of head cleaning so that an amount of solvent corresponding to the air injected from the air injection unit 109b is supplied and leakage of the solvent from the ejection port 10a is suppressed. For example, the cleaning management unit 101d executes processing of filling the solvent up to the solvent supply pipe 54 on the upstream side of the 12th valve V12 and processing of discharging the solvent from the solvent supply pipe 54 on the downstream side of the 12th valve V12. Therefore, a fixed amount of solvent can be used as much as possible at the time of head cleaning, so that the amount of solvent used at the time of head cleaning is managed. This makes it possible to suppress the solvent from leaking from the ejection port 10a at the time of head cleaning.

The error detection unit 101b executes error detection processing after the in-line cleaning operation by the cleaning control unit 101a. Then, when the process proceeds to step SB10 illustrated in FIG. 8, in a case where the error detection unit 101b detects an error related to ink contamination after the in-line cleaning operation by the cleaning control unit 101a, the controller 100 prompts the user to perform cleaning by the cleaning and placing unit 200. When the cleaning control unit 101a causes the display unit (notification unit) 103a to display a message or a drawing, it is possible to prompt the user to perform cleaning by the cleaning and placing unit 200. The message or the drawing displayed on the display unit 103a indicates that it is better to perform cleaning by the cleaning and placing unit 200. In addition, a speaker (notification unit) or the like may be provided in advance, and the user may be prompted to perform cleaning by the cleaning and placing unit 200 using sound or the like.

By providing the determination step of Step SB9 illustrated in FIG. 8, the controller 100 can cause the error detection unit 101b to detect an error related to ink contamination after the in-line cleaning operation by the cleaning control unit 101a and cause the cleaning control unit 101a to execute the in-line cleaning operation again. The cleaning control unit 101a prompts the user to replace the print head 1 in a case where the error detection unit 101b detects an error related to ink contamination after a plurality of times of in-line cleaning operations. In this case as well, the cleaning control unit 101a can prompt the user to replace the print head 1 by displaying a message or a drawing on the display unit 103a or generating a sound from a speaker or the like, as in the case of prompting the user to perform cleaning by the cleaning and placing unit 200.

In a case where the error detection unit 101b detects an error related to ink contamination, the controller 100 executes control not to execute printing on the print head 1. That is, in a case where an error related to ink contamination occurs, it is estimated that normal printing cannot be performed. Therefore, in such a case, maintenance such as cleaning is prompted to the user by not executing printing.

### Recovery possibility determination function

During operation or start-up of the ink jet recording apparatus I, ink particles may not be appropriately ejected from the print head 1, and a printing error may occur. At this time, as the cause of the printing error, for example, in addition to the abnormality of the pumps P1 to P4 and the clogging of the ink flow path in the controller 100, the clogging of the print nozzle 12 in the print head 1, the failure of the charging electrode 13 and the deflection electrode 15, and the like are considered variously, and it is difficult for the user to determine the true cause at a glance.

In particular, in a case where the head module 1B in which the charging electrode 13, the deflection electrode 15, and the like are modularized is provided as in the present embodiment, it is not easy to grasp whether the printing error is recovered if the head module 1B is replaced with a new one, or whether the error is not recovered even if the head module 1B is replaced with a new one as in the case of the abnormality of the pumps P1 to P4 in the controller 100, for example. That is, it is difficult for a user to determine an appropriate replacement timing of the print head 1. Furthermore, in a case where the cause of the printing error is unknown, it is conceivable to send the print head 1 and the controller 100, which are integrated by the connection cable 1000 and cannot be separated, to a repair shop as described above. However, it takes a long time to recover from the error, and as a result, for example, downtime of a production line is prolonged.

On the other hand, the ink jet recording apparatus I according to the present embodiment has a recovery possibility determination function that determines the recovery possibility by replacement of the head module 1B in a case where a printing error occurs, and enables the user to grasp the necessity of replacement of the head module 1B in a short time toward recovery of the error.

The controller 100 includes the above-described error detection unit 101b as an operation state detection unit that detects the operation state of the ink jet recording apparatus I. The error detection unit 101b detects various errors occurring in the ink jet recording apparatus I as the operation state of the ink jet recording apparatus I. As described above, the error that can be detected by the error detection unit 101b is an error in which the factor is the print head 1, an error in which the factor is the print head 1 or an error in which there is a possibility that the factor is other than the print head 1, an error in which the factor is limited to something other than the print head 1, or the like.

The controller 100 includes a determination unit 101e that determines the recovery possibility of the error. In a case where the error is detected by the error detection unit 101b, the determination unit 101e acquires the type of error detected by the error detection unit 101b as the operation state of the ink jet recording apparatus I. In a case where an error has occurred in the ink jet recording apparatus I, the determination unit 101e determines the recovery possibility of the error due to the replacement of the head module 1B with respect to the head body 1A on the basis of the operation state of the ink jet recording apparatus I detected by the error detection unit 101b. Specifically, the determination unit 101e determines the recovery possibility of the error due to the replacement of the head module 1B with respect to the head body 1A on the basis of the type of error detected by the error detection unit 101b. For example, the determination unit 101e determines whether the factor of the error detected by the error detection unit 101b is in the controller 100 or not, and whether the factor is in the head module 1B or not. At that time, after it is determined whether or not the factor of the error is in the controller 100, it is determined whether or not the factor of the error is in the head module 1B.

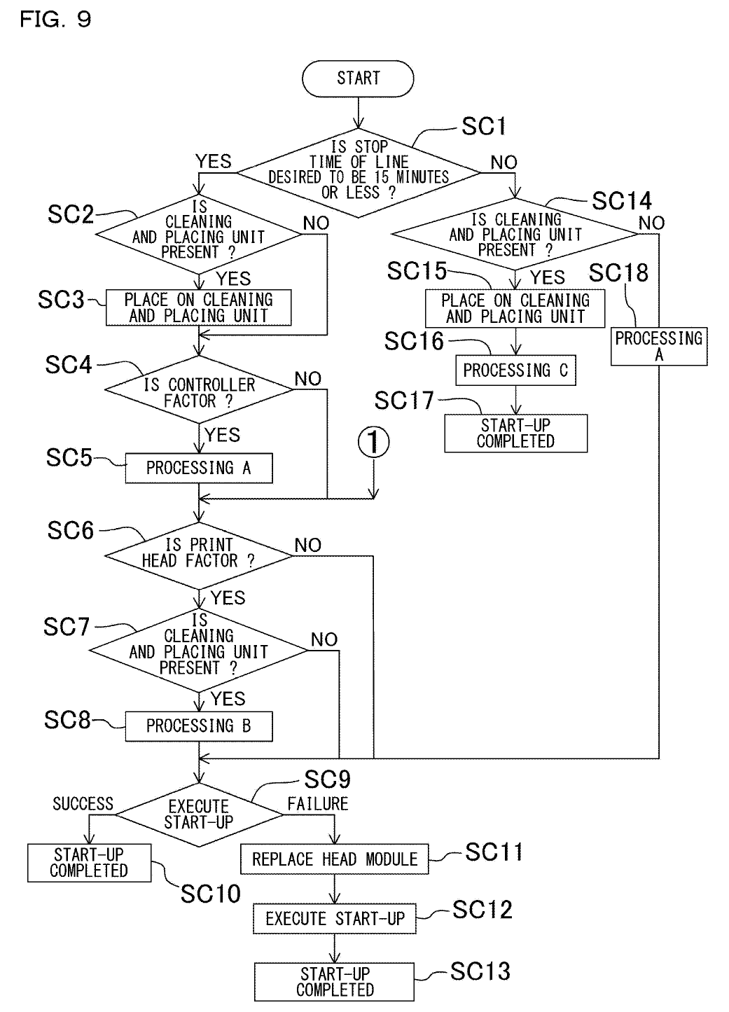

Hereinafter, processing when an error occurs will be described with reference to the flowchart illustrated in FIG. 9. This flow is started in a case where the error detection unit 101b detects any error. In step SC1, the determination unit 101e determines whether or not it is desired to set the stop time of the production line due to the occurrence of the error to 15 minutes or less. Whether or not the stop time of the production line due to the occurrence of the error is desired to be 15 minutes or less is input by the user by initial setting, and thus the determination unit 101e executes the determination of step SC1 with reference to the user's initial setting. “15 minutes” is an example, and may be a predetermined time at which the user desires recovery. The same applies hereinafter.

In a case where it is desired to set the stop time of the production line to 15 minutes or less, the process proceeds to step SC2. In step SC2, the determination unit 101e determines whether or not the cleaning and placing unit 200 is connected to the controller 100. Since the user also inputs whether or not the cleaning and placing unit 200 is connected to the controller 100 by the initial setting, the determination unit 101e executes the determination of step SC2 with reference to the initial setting of the user.

In a case where the cleaning and placing unit 200 is connected to the controller 100, the process proceeds to step SC3. In step SC3, the user places the print head 1 on the cleaning and placing unit 200. In processing A in step SA5 to be described later, it is not essential to place the print head 1 on the cleaning and placing unit 200, but the print head 1 is placed on the cleaning and placing unit 200 in step SC3. In a case where the cleaning and placing unit 200 is not connected to the controller 100, step SC3 is skipped.

In step SC4, the determination unit 101e determines whether or not the factor of the error detected by the error detection unit 101b is in the controller 100. In a case where the factor of the error is in the controller 100, the process proceeds to step SC5 to execute the processing A to be described later. On the other hand, in a case where the factor of the error is not in the controller 100, step SC5 is skipped.

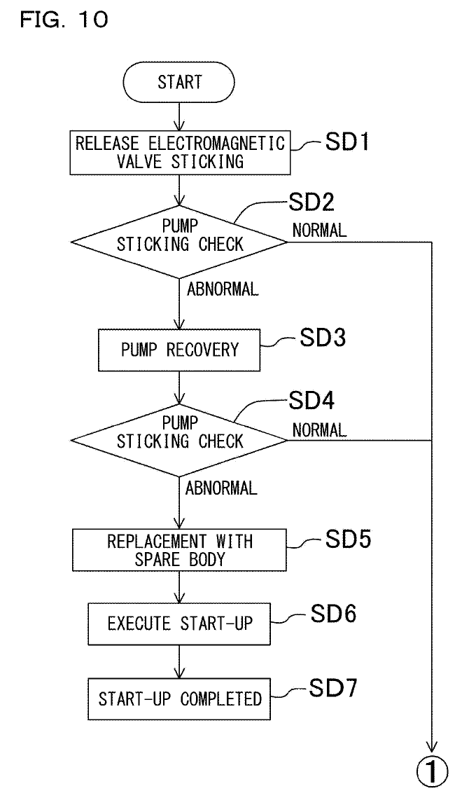

Details of the processing A will be described on the basis of the flowchart illustrated in FIG. 10. The processing A is processing of checking whether components other than the print head 1 are normal, and if there is a problem, the processing A is performed until recovery. Portions that may become errors are, for example, the electromagnetic valve and the first to fourth pumps P1 to P4, and thus, they are to be checked. Note that, in addition, a failure of a pressure reducing valve or filter clogging may occur, but these troubles can also be checked by a sticking check of the pump.

In step SD1, the determination unit 101e executes sticking release processing for each electromagnetic valve. In the sticking release processing of each electromagnetic valve, the determination unit 101e performs processing of opening and closing each electromagnetic valve a plurality of times at regular intervals.

In step SD2, the determination unit 101e performs the sticking check of the first to fourth pumps P1 to P4. In this manner, in a case where the determination unit 101e determines that the factor of the error detected by the error detection unit 101b is in the controller 100, the determination unit 101e determines whether or not the first to fourth pumps P1 to P4 included in the controller 100 are stuck. When determining whether or not the pump is stuck, the determination unit 101e determines whether or not at least one pump of the first to fourth pumps P1 to P4 included in the controller 100, that is, at least one pump of a solvent feeding pump, an ink feeding pump, an ink circulating pump, and a gutter pump that feeds the ink collected by the gutter 16 is stuck. In the pump sticking check of the present embodiment, the determination unit 101e executes the following processing on each of the first to fourth pumps P1 to P4 in the controller 100 to determine whether or not the pumps are stuck.

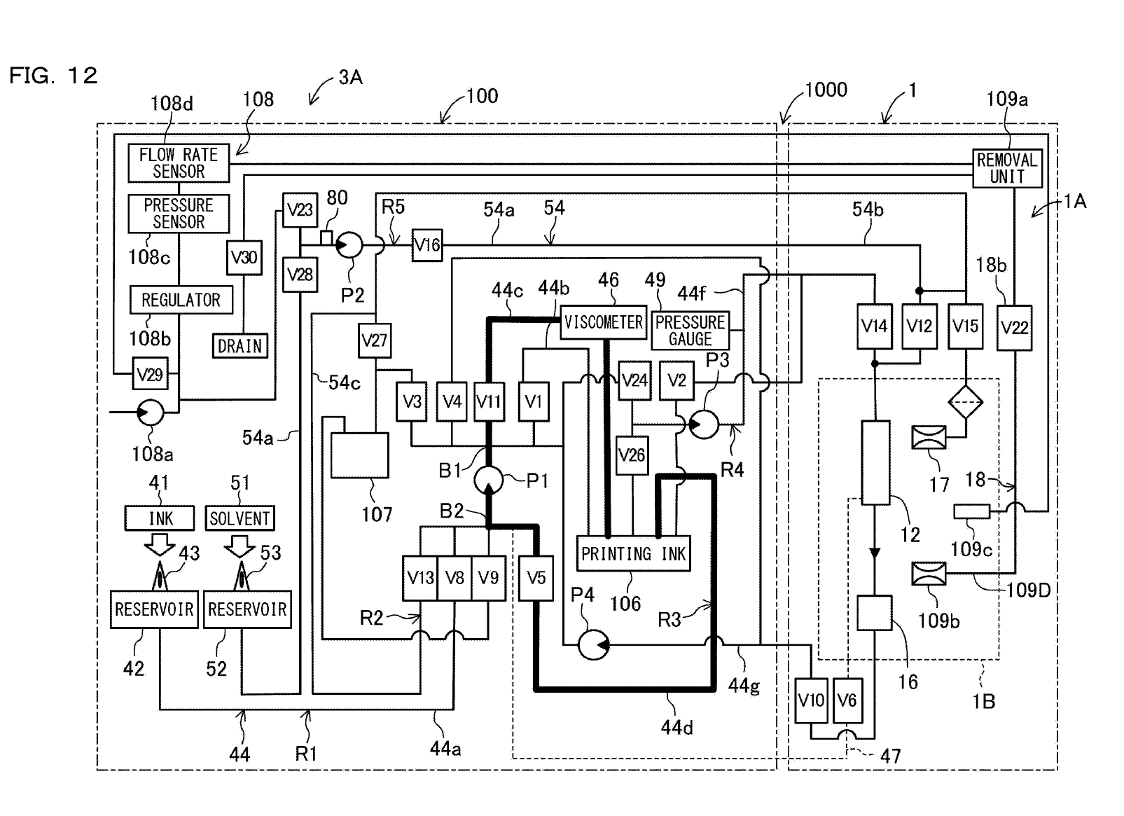

In the sticking check of the first pump P1, an activation signal is output to the first pump P1, and the fifth valve V5 and the 11th valve V11 are brought into an open state to allow the ink to flow into the viscometer 46 (see FIG. 12). In FIG. 12, the path used for the sticking check of the first pump P1 is indicated by a thick line. At that time, the presence or absence of sticking is determined on the basis of whether the level meter of the viscometer 46 reacts, that is, whether the ink has actually been introduced. If the level meter of the viscometer 46 reacts, it can be determined that the first pump P1 is normal, and if the level meter of the viscometer 46 does not react, it can be determined that the first pump P1 is abnormal.

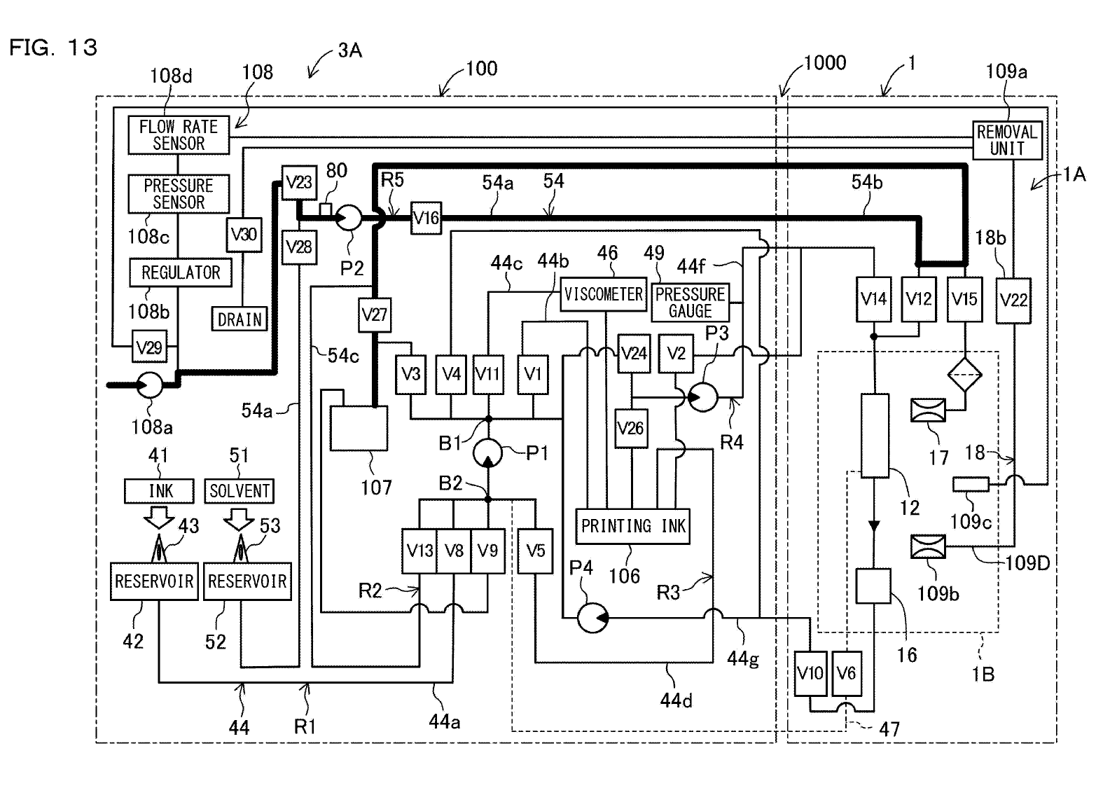

In the sticking check of the second pump P2, the 23rd valve V23, the 16th valve V16, and the 27th valve V27 are brought into an open state, and the air pump 108a is activated to push out the solvent in the solvent supply pipe 54 (see FIG. 13). In FIG. 13, the path used for the sticking check of the second pump P2 is indicated by a thick line. At this time, an empty detection sensor 80 is provided on the upstream side of the second pump P2, and the empty detection sensor 80 is made to detect empty. Thereafter, the 28th valve V28 and the 16th valve V16 are brought into an open state, and an activation signal is output to the second pump P2. When the empty detection sensor 80 remains in the empty detection even after a lapse of a certain period of time, it is determined that the second pump P2 is stuck and the solvent cannot be fed.

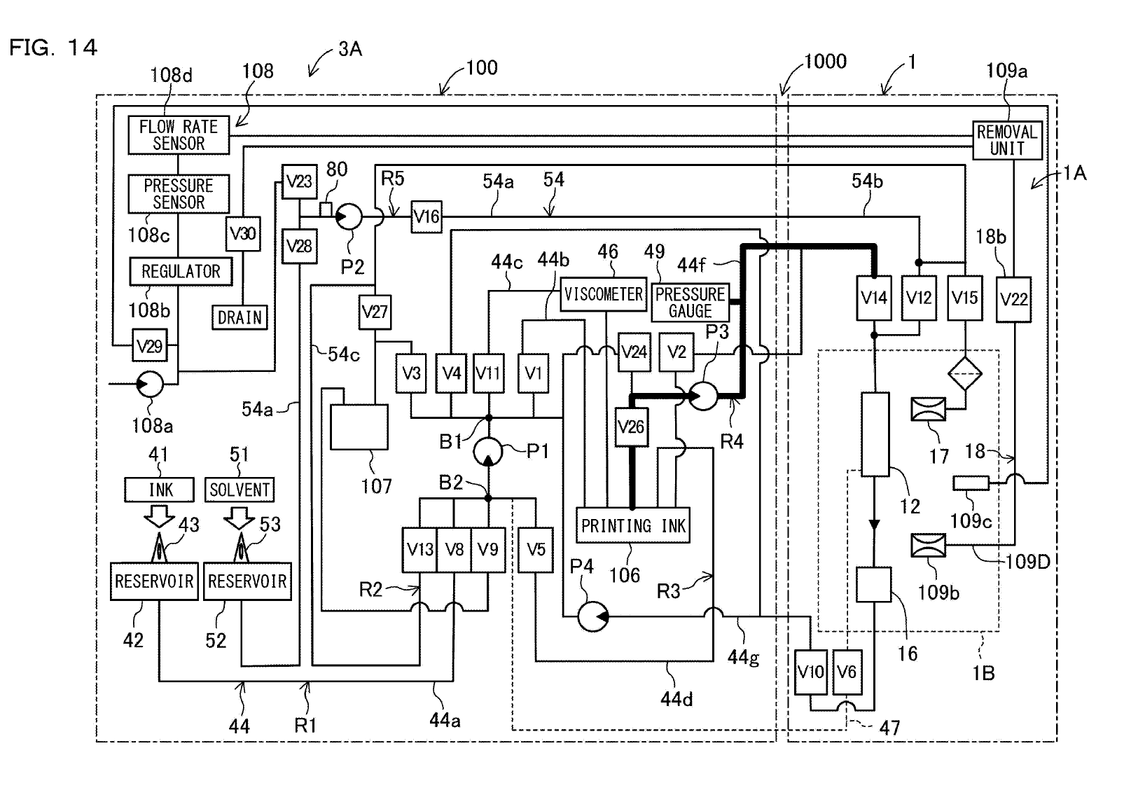

In the sticking check of the third pump P3, an activation signal is output to the third pump P3, and the 26th valve V26 is brought into an open state (see FIG. 14). In FIG. 14, the path used for the sticking check of the third pump P3 is indicated by a thick line. It is checked whether the pressure value in the ink supply pipe 44 becomes more than or equal to a certain value within a certain period of time. If the pressure value in the ink supply pipe 44 becomes more than or equal to the certain value within the certain period of time, it is determined that the third pump P3 is normally operating, and if not, it is determined that the third pump P3 is stuck.

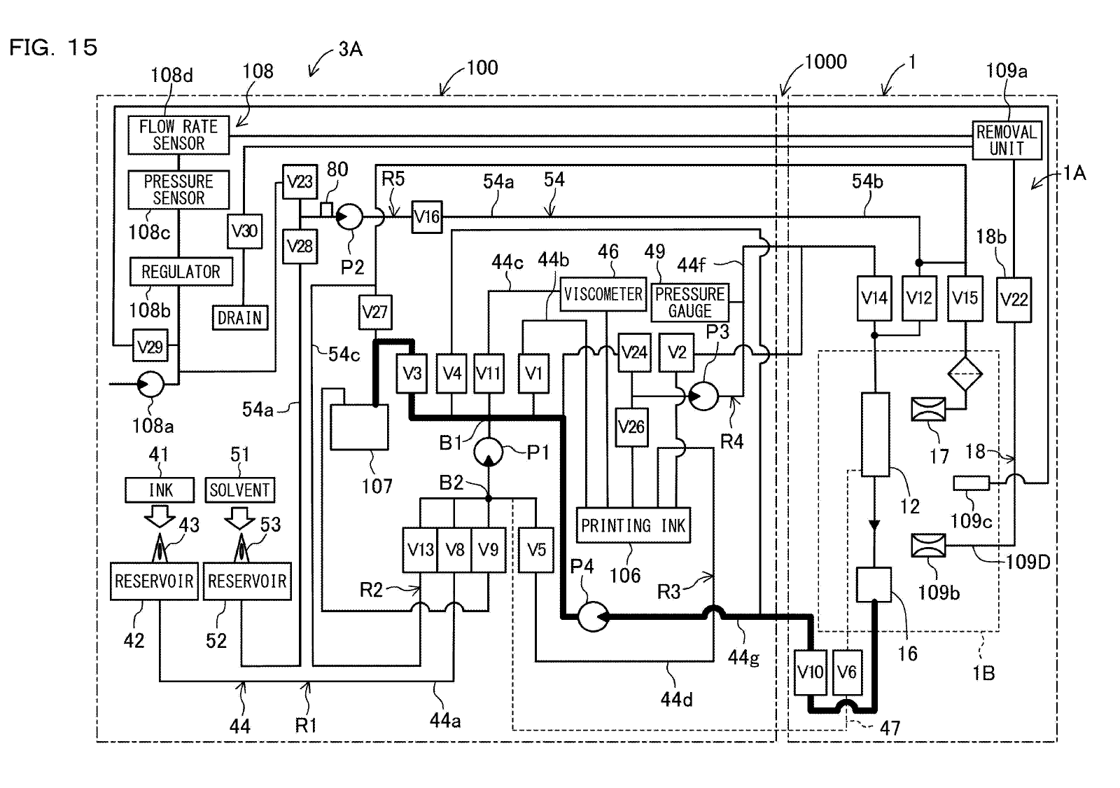

In the sticking check of the fourth pump P4, the gutter sensor 16b provided in the gutter 16 is used. The gutter sensor 16b is usually used to check whether the ink shaft ejected from the print nozzle 12 is in the gutter 16, but since it is also possible to check whether there is a flow of air, the gutter sensor 16b is used to check whether the fourth pump P4 is stuck. Specifically, the third valve V3 and the 10th valve V10 are brought into an open state, an activation signal is output to the fourth pump P4, and a flow of air is generated in the gutter 16 (see FIG. 15). In FIG. 15, the path used for the sticking check of the fourth pump P4 is indicated by a thick line. A detection value (resistance value) of the gutter sensor 16b is checked to check whether a flow of air is generated in the gutter 16. If there is a flow of air in the gutter 16, it is determined that the fourth pump P4 is operating normally, and if there is no flow of air in the gutter 16, it is determined that the fourth pump P4 is stuck.

After the sticking check of the pumps P1 to P4 is performed in step SD2 of FIG. 10, if an abnormality occurs, the process proceeds to step SD3. In step SD3, the determination unit 101e executes pump recovery processing (sticking release processing).

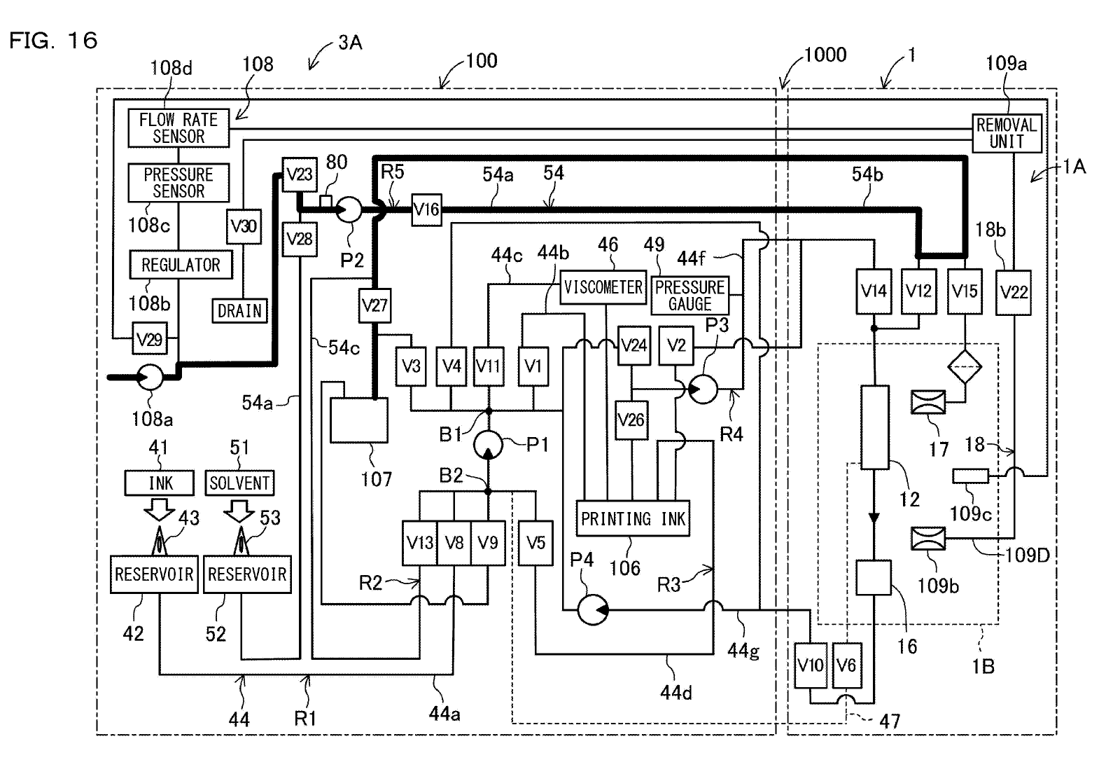

In the sticking release processing of the second pump P2, the 23rd valve V23, the 16th valve V16, and the 27th valve V27 are brought into an open state, and the air pump 108a is driven for a certain period of time to apply pressure, thereby releasing the sticking (see FIG. 16). In FIG. 16, the path used for the sticking release processing of the second pump P2 is indicated by a thick line.

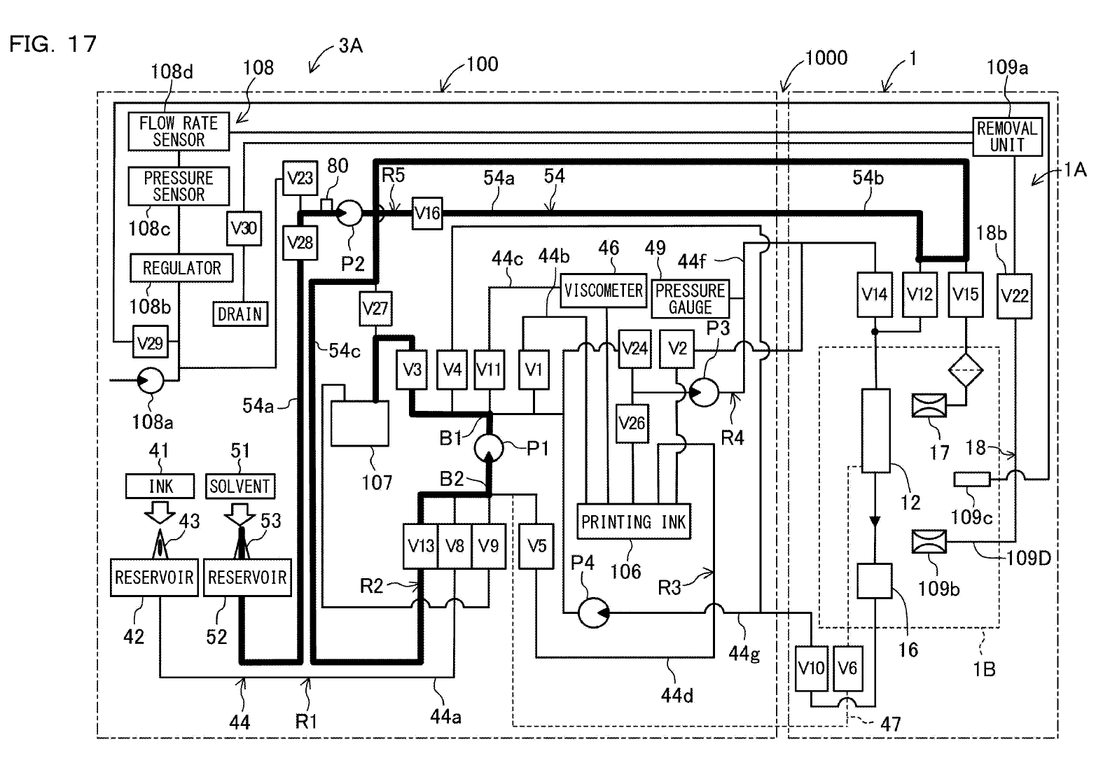

Since the sticking release processing of the first pump P1 is based on the premise that the second pump P2 is not stuck, in a case where the second pump P2 is stuck, the sticking of the second pump P2 is released first. In the sticking release processing of the first pump P1, the 28th valve V28, the 16th valve V16, the 13th valve V13, and the third valve V3 are brought into an open state, the solvent sucked out of the solvent cartridge is immersed in each pump, and the second pump P2 is driven for a certain period of time to apply pressure while dissolving the sticking component (ink), thereby releasing the sticking (see FIG. 17). In FIG. 17, the path used for the sticking release processing of the first pump P1 is indicated by a thick line.

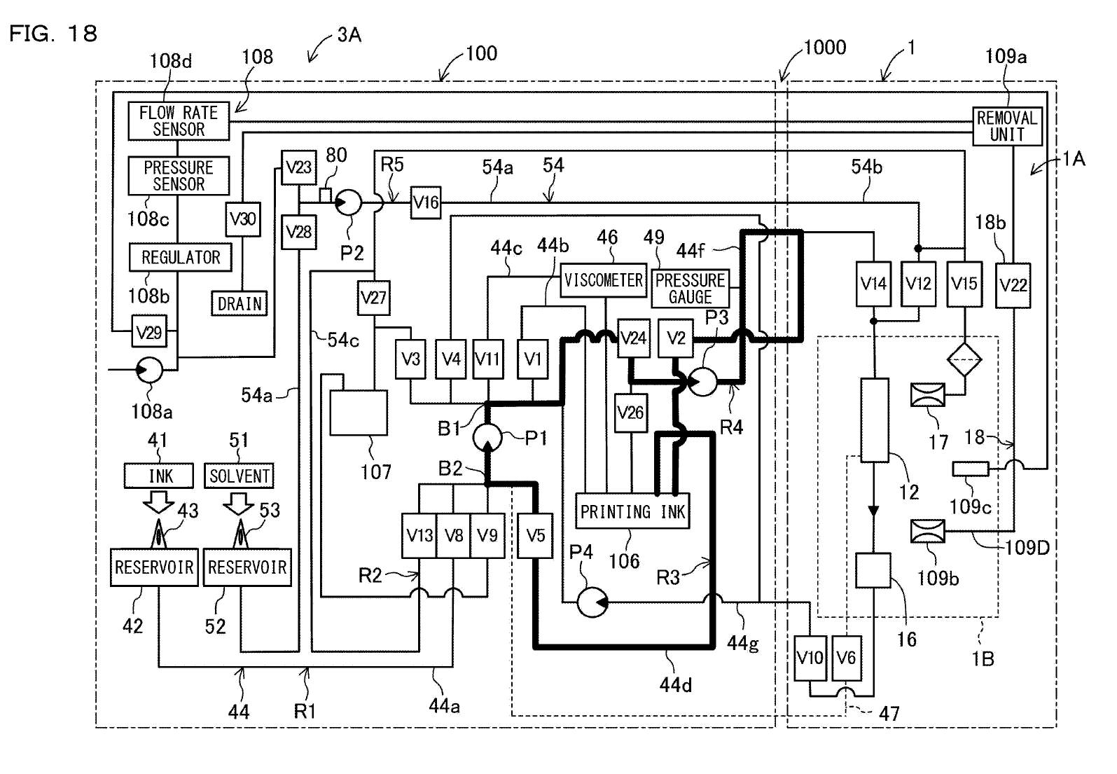

Since the sticking release processing of the third pump P3 is based on the premise that the first pump P1 and the second pump P2 are not stuck, in a case where the first pump P1 and the second pump P2 are stuck, the sticking of the first pump P1 and the second pump P2 is released first. In the sticking release processing of the third pump P3, the fifth valve V5, the 24th valve V24, and the second valve V2 are brought into an open state, and the first pump P1 and the second pump P2 are driven for a certain period of time to apply pressure, thereby releasing the sticking (see FIG. 18). In FIG. 18, the path used for the sticking release processing of the third pump P3 is indicated by a thick line.

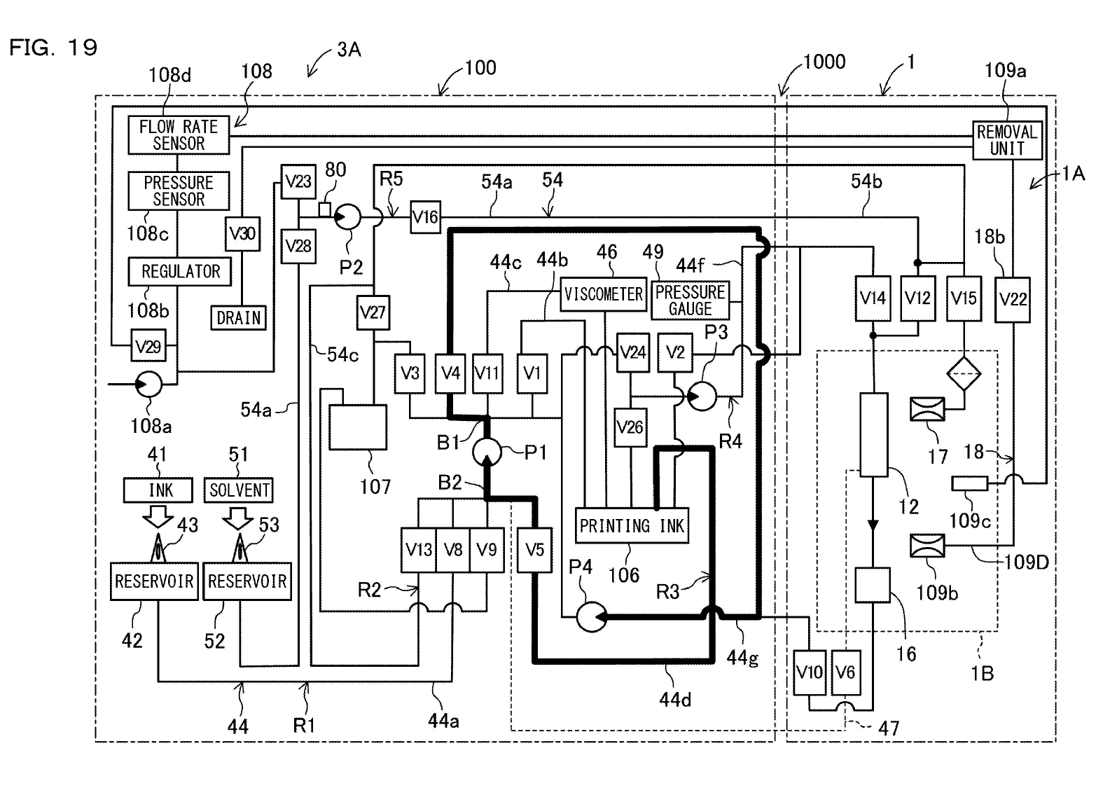

Since the sticking release of the fourth pump P4 is based on the premise that the first pump P1 and the second pump P2 are not stuck, in a case where the first pump P1 and the second pump P2 are stuck, the sticking of the first pump P1 and the second pump P2 is released first. In the sticking release processing of the fourth pump P4, the fifth valve V5 and the fourth valve V4 are brought into an open state, and the air pump 108a is driven for a certain period of time to apply pressure, thereby releasing the sticking (see FIG. 19). In FIG. 19, the path used for the sticking release processing of the fourth pump P4 is indicated by a thick line.

After step SD3 in FIG. 10, the process proceeds to step SD4, and similarly to step SD2, the determination unit 101e executes the sticking check of the first to fourth pumps P1 to P4. In a case where it is determined in step SD4 that the first to fourth pumps P1 to P4 are stuck, replacement of the controller 100 with a spare body is prompted in step SD5. When prompting the replacement with the spare body, the determination unit 101e displays a message or a drawing on the display unit 103a. The message or the drawing displayed on the display unit 103a indicates that it is better to perform replacement with the spare body. In addition, a speaker or the like may be provided in advance, and the user may be prompted to perform replacement with the spare body by using voice or the like.

In step SD6, the start-up processing execution unit 101f executes the start-up processing after the replacement with the spare body. In step SD7, it is confirmed that the start-up processing by the start-up processing execution unit 101f has been completed.

After the processing A, and in a case where it is determined that the first to fourth pumps P1 to P4 are normal in steps SD2 and SD4, the process proceeds to step SC6 illustrated in FIG. 9. Proceeding to step SC6 means that there is no error due to the controller 100. In step SC6, the determination unit 101e determines whether or not a factor of the error detected by the error detection unit 101b is in the print head 1, that is, the head module 1B. In a case where the factor of the error is in the head module 1B, the process proceeds to step SC7, and it is determined whether or not the cleaning and placing unit 200 is connected to the controller 100. In a case where the cleaning and placing unit 200 is connected to the controller 100, the process proceeds to step SC8, and the cleaning control unit 101a executes processing B.

In the processing B, nozzle dissolving cleaning processing for releasing clogging of the print nozzle 12 and processing of spraying a solvent to the print nozzle 12 and the deflection electrode 15 by the cleaning nozzle 17 are executed.

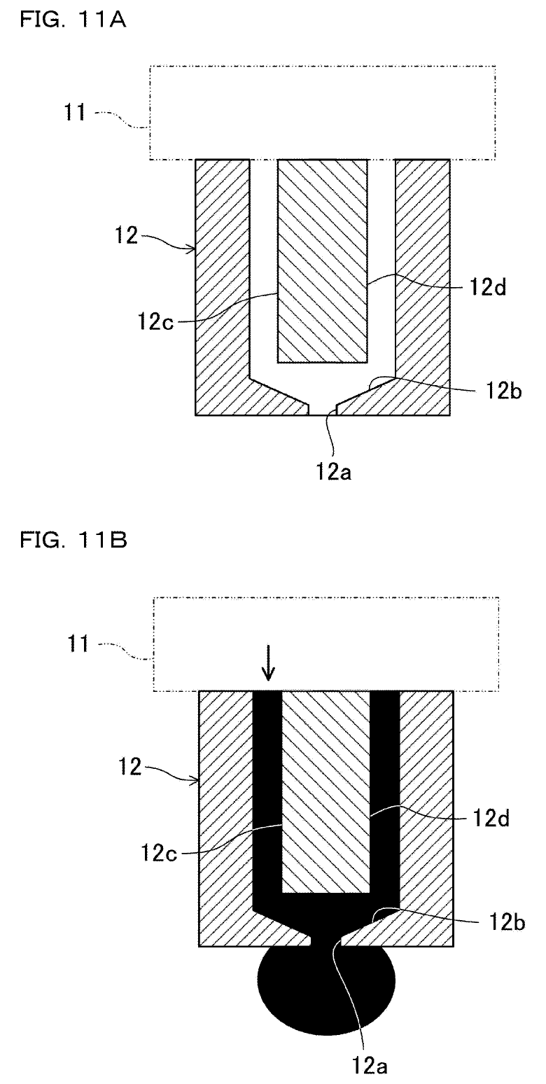

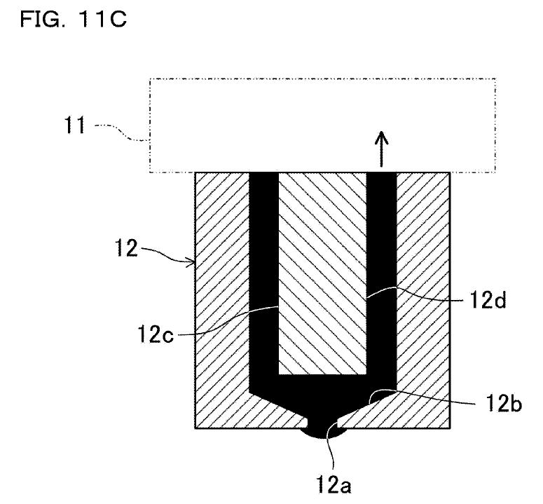

An example of the nozzle dissolving cleaning processing will be described. FIG. 11A is a cross-sectional view of the print nozzle. On a lower end surface of a main body portion of the print nozzle 12, an ejection port 12a from which the ink vibrated by the pressurizer 11 is ejected is formed to open downward. Inside the main body portion of the print nozzle 12, an accumulation portion 12b including a space capable of temporarily accumulating ink to which vibration is applied by the pressurizer 11 is formed between the pressurizer 11 and the ejection port 12a. The ejection port 12a communicates with a lower portion of the accumulation portion 12b.

Moreover, an in-nozzle supply path 12c and an in-nozzle suction passage 12d are formed inside the main body portion of the print nozzle 12. The in-nozzle supply path 12c extends in the upper-lower direction inside the main body portion of the print nozzle 12, and the lower end portion of the in-nozzle supply path 12c is connected to the accumulation portion 12b. The ink supplied from the controller 100 flows into the upper end portion of the in-nozzle supply path 12c. The in-nozzle suction passage 12d is a path for sucking the ink accumulated in the accumulation portion 12b.

In the nozzle dissolving cleaning processing, the cleaning control unit 101a controls the controller 100 so that the ink is supplied to the accumulation portion 12b of the print nozzle 12 to leak the ink from the ejection port 12a of the print nozzle 12, and stops the supply of the ink before the ink that has leaked from the ejection port 12a and has become a droplet due to surface tension separates from the print nozzle 12 as illustrated in FIG. 11B. Therefore, the droplet ink is maintained in a state of being attached to the periphery of the ejection port 12a, and thus the solidified dirt component is dissolved in the ink.

Before the solvent contained in the ink in the form of droplets is completely evaporated, the cleaning control unit 101a controls the controller 100 so that the ink in the form of droplets is sucked through the in-nozzle suction passage 12d. Therefore, as illustrated in FIG. 11C, the ink in the form of droplets disappears, and the dirt component can be removed from the print nozzle 12. As described above, the cleaning control unit 101a cleans the print nozzle 12 in a case where the determination unit 101e determines that the factor of the error is in the head module 1B.

After the processing B, the process proceeds to step SC9, and the start-up processing execution unit 101f executes the start-up processing. After cleaning the print nozzle 12 by the cleaning control unit 101a, the start-up processing execution unit 101f executes the start-up processing of collecting the ink ejected from the print nozzle 12 in the gutter 16 and circulating the ink.

In a case where the start-up processing by the start-up processing execution unit 101f is successful, the process proceeds to step SC10 to confirm that the start-up processing has been completed. In a case where the start-up processing execution unit 101f fails in the start-up in step SC9, the process proceeds to step SC11. In step SC11, in a case where the start-up processing execution unit 101f fails in the start-up processing, the determination unit 101e determines that there is a recovery possibility of an error due to replacement of the head module 1B with respect to the head body 1A.

In a case where the determination unit 101e determines that there is the recovery possibility of the error due to the replacement of the head module 1B, the user is prompted to replace the head module 1B. When the replacement of the head module 1B is prompted, the determination unit 101e causes the display unit 103a to display a message or a drawing. The message or the drawing displayed on the display unit 103a indicates that it is better to perform replacement of the head module 1B. In addition, a speaker or the like may be provided, and the user may be prompted to replace the head module 1B by using voice or the like.

When the user replaces the head module 1B with a normally operating head module 1B, the process proceeds to step SC12, and the start-up processing execution unit 101f executes the start-up processing. Since the error factor is only in the head module 1B, if the head module 1B is replaced in step SC11, the start-up processing is successful in step SC12. The process proceeds to step SC13, and it is confirmed that the start-up processing has been completed.

In a case where the start-up processing execution unit 101f fails in the start-up processing, the cleaning control unit 101a may execute control to increase an amount of liquid used for cleaning the print nozzle 12 as compared with the case where the start-up processing is successful. That is, before replacing the head module 1B in a case where the start-up processing execution unit 101f fails in the start-up processing, the cleaning control unit 101a increases the amount of liquid used for cleaning the print nozzle 12 and executes the cleaning operation. Therefore, when the clogging of the print nozzle 12 is eliminated, recovery can be performed without replacing the head module 1B.

Furthermore, in a case where the start-up processing execution unit 101f fails in the start-up processing, the cleaning control unit 101a may execute control to lengthen the cleaning time of the print nozzle 12 as compared with the case where the start-up processing is successful. That is, the cleaning control unit 101a extends the cleaning time of the print nozzle 12 before replacing the head module 1B in a case where the start-up processing execution unit 101f fails in the start-up processing. Therefore, when the clogging of the print nozzle 12 is eliminated, recovery can be performed without replacing the head module 1B.

Furthermore, in a case where the start-up processing fails, the start-up processing execution unit 101f can execute the start-up processing again. The clogging of the print nozzle 12 may be eliminated by attempting again the execution of the start-up processing of collecting the ink ejected from the print nozzle 12 into the gutter 16 and circulating the ink.

In step SC1, in a case where the stop time of the production line due to the occurrence of the error does not need to be suppressed to 15 minutes or less, the process proceeds to step SC14. In step SC14, the determination unit 101e determines whether or not the cleaning and placing unit 200 is connected to the controller 100. In a case where the cleaning and placing unit 200 is not connected to the controller 100, the process proceeds to step SC18, and the above-described processing A is executed. After step SC18, the process proceeds to step SC9.

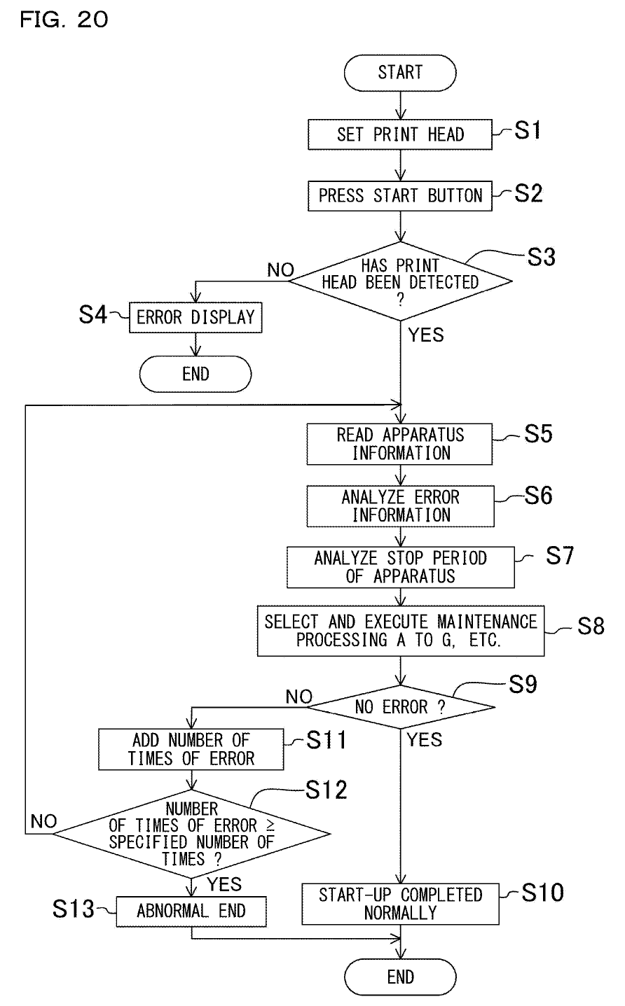

In a case where the cleaning and placing unit 200 is connected to the controller 100, the process proceeds to step SC15. In step SC15, the print head 1 is placed on the cleaning and placing unit 200. In step SC16, the cleaning control unit 101a executes processing C. FIG. 20 is a flowchart illustrating details of the processing C.

In step S1, the print head 1 is installed on (attached to) the cleaning and placing unit 200. In subsequent step S2, the user presses the operation unit 103b as a start button. In step S3, the cleaning control unit 101a determines whether or not the print head 1 has been detected. In a case where the determination is NO, the process proceeds to step S4.

In a case where the determination in step S3 is YES, the process proceeds from step S3 to step S5. In this case, the cleaning control unit 101a reads apparatus information from the storage unit 102. The apparatus information read in step S5 may include, for example, information related to a maintenance operation previously executed and information indicating an execution result thereof, in addition to error information (latest error information) and a stop period of the apparatus. Specifically, the cleaning control unit 101a refers to the error information at the time of the previous stop as the latest error information.

In step S6, the cleaning control unit 101a analyzes the error information read from the storage unit 102. Similarly, in step S7 subsequent to step S6, the control unit 101 analyzes a stop period (stop period of the apparatus) measured by, for example, a timer or the like.

In step S8, the cleaning control unit 101a determines a selection condition combining the error information and the stop period, and collates the selection condition with a table for specifying the contents of the maintenance operation. The cleaning control unit 101a selects and executes the contents of the maintenance operation to be performed on the print head 1 from the maintenance processing A to G by collating the selection condition.

Each of the maintenance processing A to G includes at least one of automatic cleaning, error release processing, and start-up processing, and the cleaning control unit 101a executes each processing in order. In step S9, the cleaning control unit 101a determines whether or not any one of the selected maintenance processing A to G has been normally completed as the maintenance operation. This determination is made on the basis of whether or not each of the automatic cleaning, the error release processing, and the start-up processing has been normally completed.

In step S10, for example, the user removes the print head 1 from the cleaning and placing unit 200. Furthermore, in a case where the determination in step S9 is NO, the process proceeds to step S11. In this case, it is determined that an error has occurred in the maintenance operation itself for releasing the error, the number of times the error has occurred in the maintenance operation so far is added by one, and the process proceeds to step S12.

In step S12, the cleaning control unit 101a determines whether or not the number of times of occurrence of an error in the maintenance operation is greater than or equal to a specified number of times. In a case where the determination is NO, the process returns to step S5. In this case, the cleaning control unit 101a starts over from the selection of the maintenance operation. On the other hand, in a case where the determination is YES, the process proceeds to step S13, and the control process is completed as an abnormal end.

After the processing C ends, the process proceeds to step SC17 in FIG. 9. In step SC17, it is confirmed that the start-up processing has been completed.

### Maintenance processing in non-mounted state of head module

As described in step SD5 of FIG. 10, in many cases, the user prepares the spare body in advance, and in a case where an error occurs, the recovery can be quickly performed by replacement with the spare body. In order to prevent ink sticking, maintenance such as ink circulation and solvent cleaning is periodically performed on the spare body, for example, about once a week.

In the present embodiment, since the head module 1B including the charging electrode 13 and the deflection electrode 15 is detachable from the head body 1A, only the head module 1B may be replaced depending on an error as illustrated in step SC11 of FIG. 9. In this case, when the head module 1B is removed from the head body 1A, for example, work such as liquid draining is required, which takes time. As a result, the downtime of the production line may be prolonged. Therefore, it is conceivable to remove the head module 1B from the head body 1A in advance, but in a state where the head module 1B is removed from the head body 1A, the above-described periodic maintenance cannot be performed, and there is a possibility that ink sticking occurs.

Therefore, in the present embodiment, even in a case where the head module 1B is not mounted to the head body 1A, the ink sticking can be suppressed by enabling the maintenance to be executed. That is, the controller 100 includes a maintenance execution unit 101g that executes maintenance in a case where the head module 1B is not mounted to the head body 1A on the basis of the detection result by the mounting detection unit 101c.

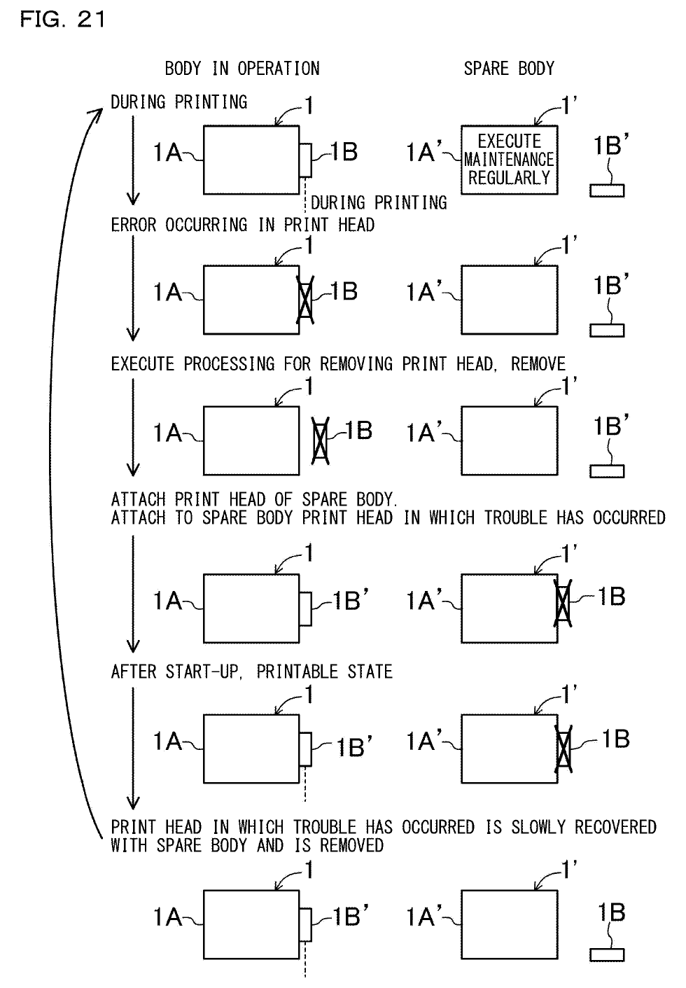

FIG. 21 is a diagram for describing a first operation mode using the spare body. A print head in operation (body in operation) is denoted by reference sign 1, a head body in operation is denoted by reference sign 1A, and a head module in operation is denoted by reference sign 1B. On the other hand, a spare print head (spare body) is denoted by reference sign 1’, a spare head body is denoted by reference sign 1A’, and a spare head module is denoted by reference sign 1B’.

When the print head 1 is in operation, the head module 1B’ is removed from the head body 1A’ of the spare print head 1’. In order to prevent ink sticking, the maintenance execution unit 101g executes maintenance. Details of the maintenance by the maintenance execution unit 101g will be described later.

When an error occurs in the head module 1B of the print head 1, the basic cleaning operation illustrated in the flowchart of FIG. 7, the cleaning operation illustrated in FIG. 8, or the like is executed as the recovery processing in a short time. In a case where the error is not recovered by the cleaning operation, replacement work of the head module 1B is performed. Specifically, the head module 1B is removed after processing (liquid draining or the like) for removing the head module 1B from the head body 1A is performed. After the head module 1B is removed from the head body 1A, the spare head module 1B’ is attached to the head body 1A. Since the spare head module 1B’ operates normally, the head module 1B’ immediately enters a printable state after the start-up processing. This prevents an increase in downtime of the production line.

The head module 1B in which the error has occurred is attached to the spare head body 1A’. The cleaning operation of the head module 1B in which the error has occurred is executed using the spare head body 1A’. For example, the basic cleaning operation illustrated in the flowchart of FIG. 7, the cleaning operation illustrated in FIG. 8, and the like are executed by the cleaning control unit 101a on the side of the spare head body 1A’. These cleaning operations can be performed slowly over time, or may be repeated many times. Therefore, the head module 1B in which the error has occurred may be recovered, and in the case of being recovered, the head module 1B can be reused.

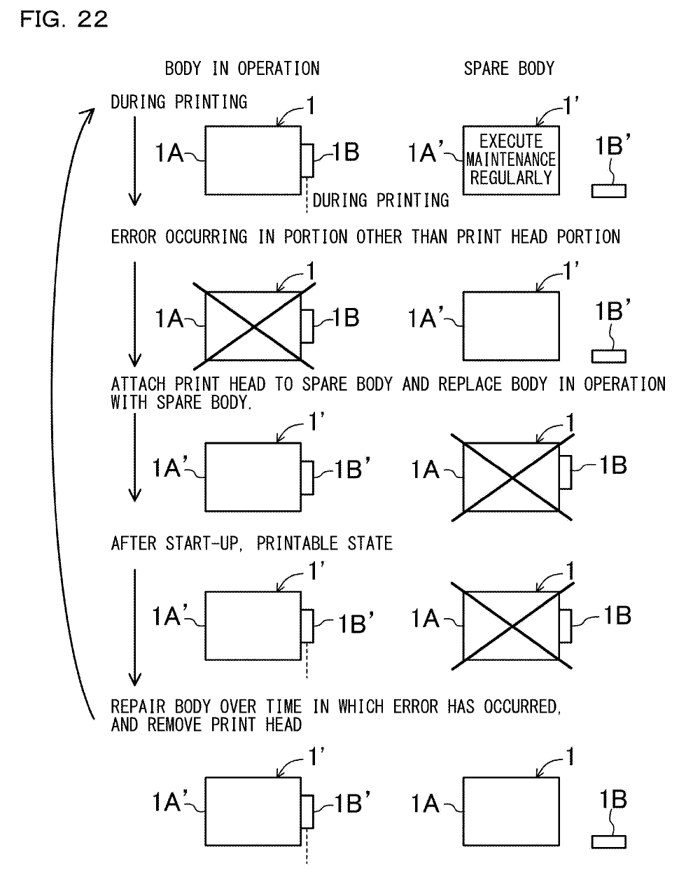

FIG. 22 is a diagram for describing a second operation mode using the spare body. The reference signs are the same as those in FIG. 21. Also in the second operation mode, when the print head 1 is operated, the head module 1B’ is removed from the head body 1A’ of the spare print head 1’. In order to prevent ink sticking, the maintenance execution unit 101g executes maintenance.

When an error occurs in the head module 1B of the print head 1, the basic cleaning operation illustrated in the flowchart of FIG. 7, the cleaning operation illustrated in FIG. 8, or the like is executed as the recovery processing in a short time. In a case where the error is not recovered by these cleaning operations, the replacement work of the print head 1 is performed. Specifically, the spare head module 1B’ is attached to the spare head body 1A’.

The print head 1 in which the error has occurred is then replaced with the spare print head 1’. In this operation example, since the head module 1B is not removed from the print head 1 in which the error has occurred, processing such as liquid draining is unnecessary.

Since the spare print head 1’ operates normally, the print head 1’ immediately enters a printable state after the start-up processing. This prevents an increase in downtime of the production line.

In the print head 1 in which the error has occurred, for example, the basic cleaning operation illustrated in the flowchart of FIG. 7, the cleaning operation illustrated in FIG. 8, and the like are executed by the cleaning control unit 101a. These cleaning operations can be performed slowly over time, or may be repeated many times. Therefore, the print head 1 in which the error has occurred may be recovered, and in the case of being recovered, the print head 1 can be reused.

The maintenance execution unit 101g receives the detection signal of the mounting detection unit 101c. The maintenance execution unit 101g executes different maintenance between a case where the mounting detection unit 101c detects that the head module 1B’ is mounted to the head body 1A’ and a case where the mounting detection unit 101c does not detect that the head module 1B’ is mounted to the head body 1A’.

Specifically, in a case where the mounting detection unit 101c detects that the head module 1B’ is mounted to the head body 1A’, the maintenance execution unit 101g executes maintenance in which the ink flows through the head module 1B’, and in a case where the mounting detection unit 101c does not detect that the head module 1B’ is mounted to the head body 1A’, the maintenance execution unit 101g executes maintenance in which the ink does not flow through the head module 1B’.

The storage unit 102 stores a maintenance table defining maintenance contents in a case where the head module 1B’ is not mounted to the head body 1A’. In a case where the mounting detection unit 101c does not detect that the head module 1B’ is mounted to the head body 1A’, the maintenance execution unit 101g executes maintenance on the basis of the maintenance table stored in the storage unit 102.

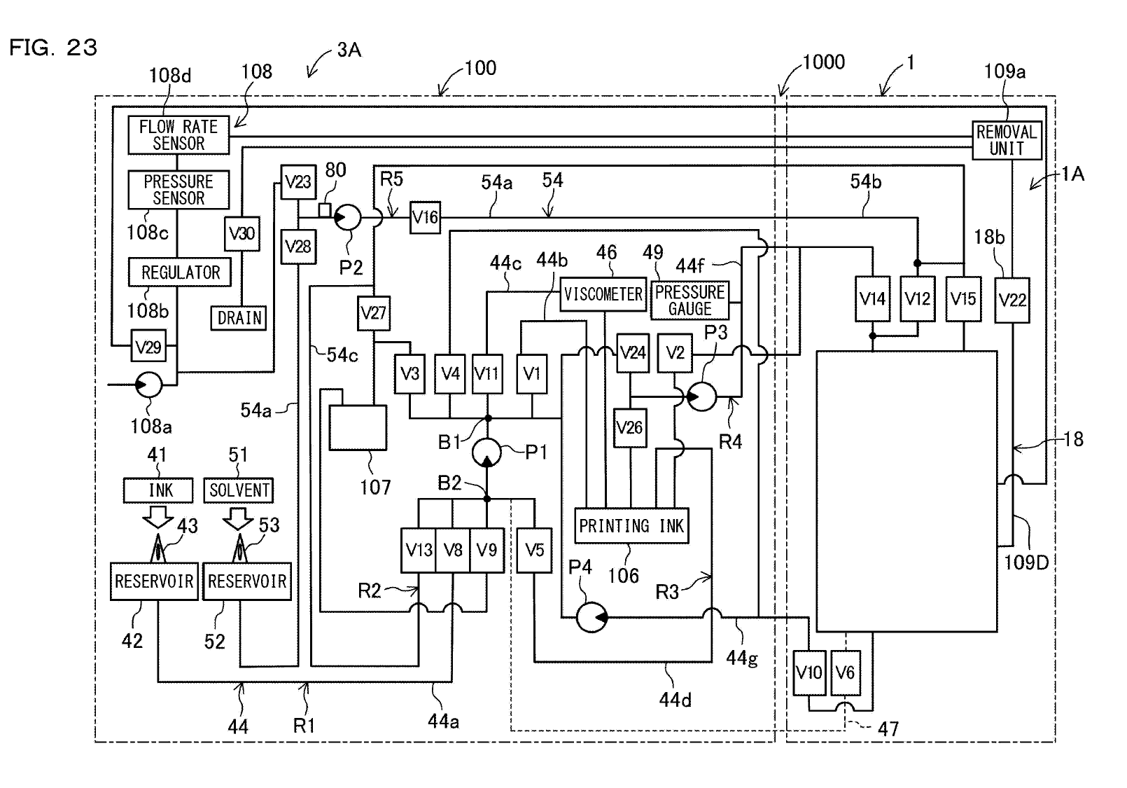

Specifically, in a case where the head module 1B’ is not mounted to the head body 1A’, the maintenance execution unit 101g executes circulation processing of circulating ink as maintenance. FIG. 23 illustrates a state in which the head module 1B’ has been removed. In a state where the head module 1B’ is removed, the 26th valve V26 and the second valve V2 are opened (the 24th valve V24 and the 14th valve V14 are in a closed state), and the third pump P3 is driven. As a result, the printing ink 106 flows through the 26th valve V26, the third pump P3, and the second valve V2 to enable ink circulation. By performing the circulation of the ink, the sticking of the ink is suppressed, and the ink can be maintained in a usable state at any time.

Here, in the maintenance in the state where the head module 1B’ is attached, the start-up processing execution unit 101f executes the normal start-up processing, that is, the processing of feeding the ink from the ink tank 106 to the head module 1B’, applying pressure to cause the ink to be ejected from the print nozzle 12, collecting the ink through the gutter 16 and the seventh ink pipe 44g, and returning the ink to the ink tank 106 again, so that the printable path state is obtained. If the processing is successful, there is no abnormality, and if the processing fails, the sticking check and release processing as illustrated in steps SD1 to SD4 of FIG. 10 is performed assuming that there is an abnormality in the path.

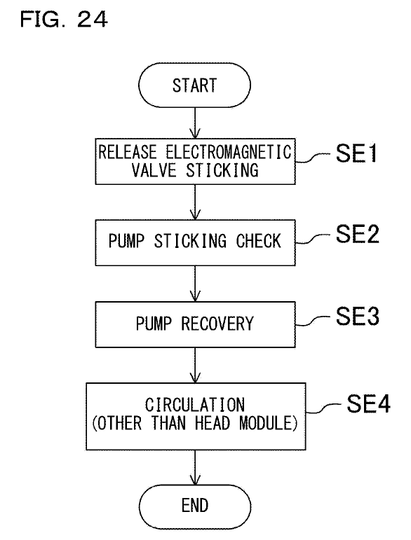

On the other hand, in the maintenance in a state where the head module 1B’ is not attached, the start-up processing execution unit 101f cannot perform the start-up processing. Therefore, since it is not possible to determine whether there is an error in the path by “whether or not the start-up has succeeded”, the maintenance execution unit 101g executes the maintenance according to the flowchart illustrated in FIG. 24. This flowchart starts in a case where the execution of the maintenance is started in a state where the mounting detection unit 101c detects that the head module 1B’ is not mounted to the head body 1A’.

In step SE1 after the start, the maintenance execution unit 101g executes the sticking release processing for each electromagnetic valve. As described above, the maintenance execution unit 101g executes the sticking release processing of the electromagnetic valves included in the controller 100 as maintenance. The sticking release processing of each electromagnetic valve is the same processing as step SD1 illustrated in FIG. 10. Thereafter, the process proceeds to step SE2, and the maintenance execution unit 101g executes the sticking check of the first to fourth pumps P1 to P4. In this manner, the maintenance execution unit 101g determines whether or not the first to fourth pumps P1 to P4 included in the controller 100 are stuck as maintenance. The sticking check of the first to fourth pumps P1 to P4 is the same processing as step SD2 illustrated in FIG. 10.

Next, the process proceeds to step SE3, and the maintenance execution unit 101g executes pump recovery processing (sticking release processing). The pump recovery processing is the same processing as step SD3 illustrated in FIG. 10. After the pump recovery processing, the process proceeds to step SE4, and the maintenance execution unit 101g executes the circulation processing of ink. At this time, as illustrated in FIG. 23, the ink is circulated in a path not included in the head module 1B’.

The maintenance execution unit 101g also executes maintenance in a case where the mounting detection unit 101c detects that the head module 1B’ is mounted to the head body 1A’. Specifically, in a case where the mounting detection unit 101c detects that the head module 1B’ is mounted to the head body 1A’, the maintenance execution unit 101g executes, as maintenance, start-up processing of collecting the ink ejected from the print nozzle 12 into the gutter 16 and circulating the ink, and circulation processing of the ink.

Moreover, in a case where the mounting detection unit 101c detects that the head module 1B’ is mounted to the head body 1A’, the maintenance execution unit 101g executes the basic cleaning operation illustrated in the flowchart of FIG. 7 and the cleaning operation including the cleaning operation illustrated in FIG. 8. Therefore, the print nozzle 12, the charging electrode 13, the deflection electrode 15, and the like included in the head module 1B’ can be cleaned.

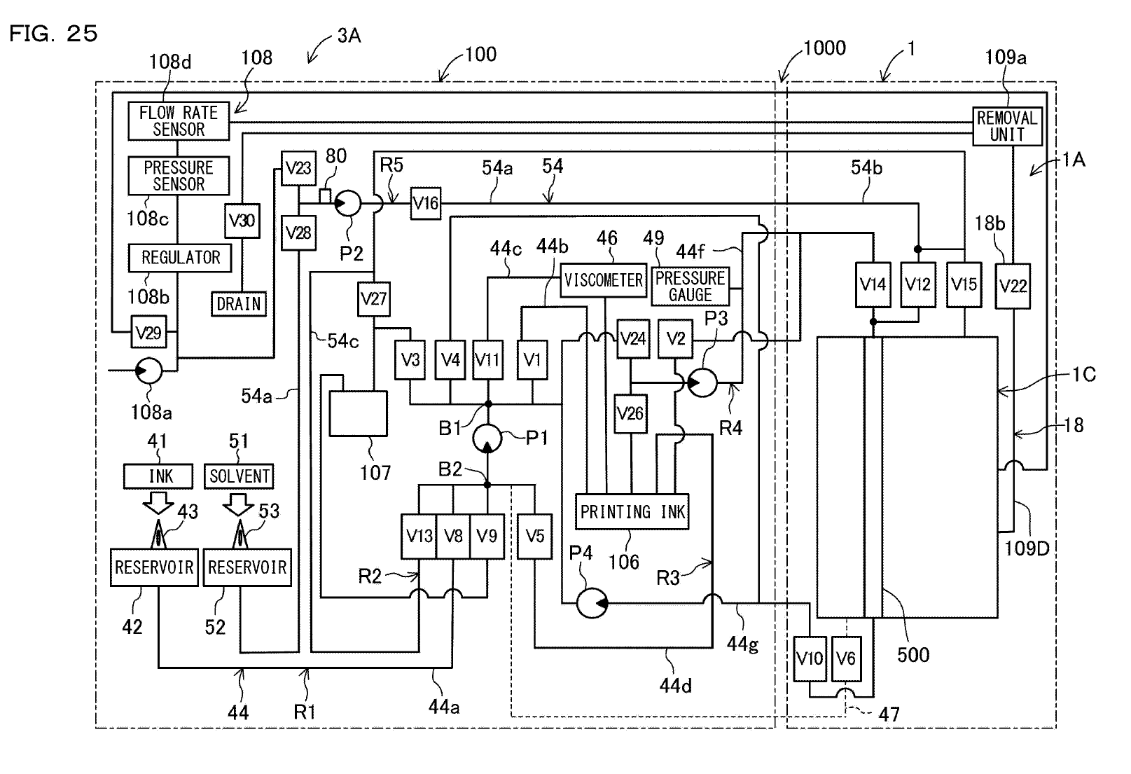

As illustrated in FIG. 25, in the head body 1A’, a member 1C in a path state different from that at the time of printing by the head module 1B’ (including 1B) can be mounted to the head body 1A’ instead of the head module 1B’. The member 1C includes a passage 500 that guides the ink ejected from the print nozzle 12 to the seventh ink pipe 44g even in a state where the head module 1B’ is removed. Such a member 1C is detachably attached to the head module 1B’, and the maintenance execution unit 101g executes maintenance in a state where the member 1C is attached to the head module 1B’.

Specifically, in a case where the member 1C in a path state different from that at the time of printing by the head module 1B’ is mounted to the head body 1A’ instead of the head module 1B’, the maintenance execution unit 101g executes the same maintenance as a case where the head module 1B’ is not mounted to the head body 1A’. This is because the member 1C does not include the print nozzle 12, the charging electrode 13, the deflection electrode 15, and the like. Note that, in a case where the head module 1B’ includes the charging electrode 13 and the deflection electrode 15, even in a case where the head module 1B’ includes only the print nozzle 12, the maintenance execution unit 101g executes the same maintenance as a case where the head module 1B’ is not mounted to the head body 1A’.

### Processing example

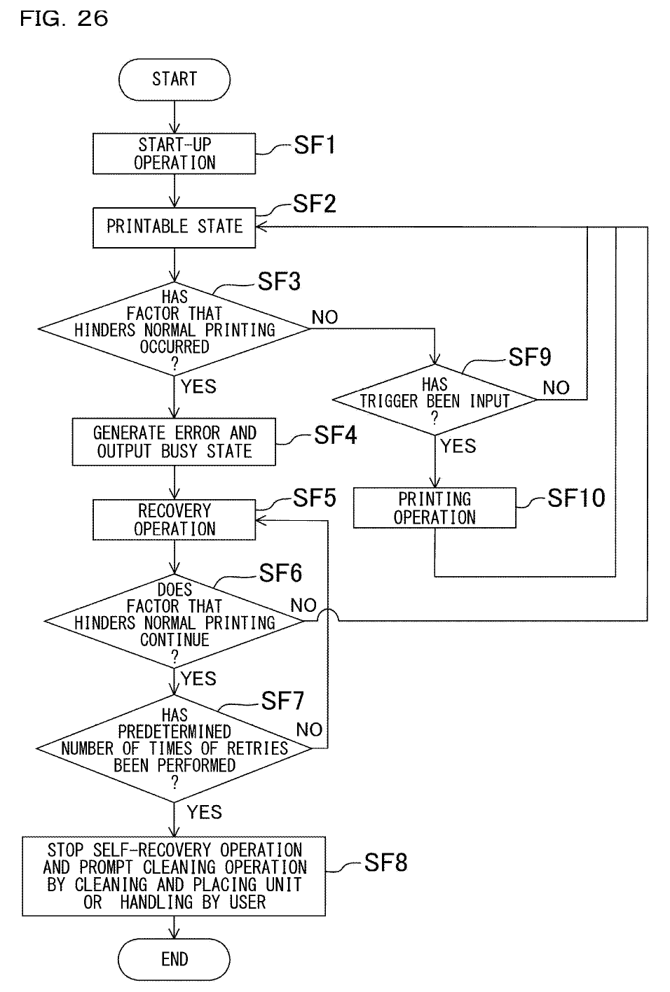

FIG. 26 is a flowchart illustrating processing in a case where an error is output even if there is no trigger input. After the start, in step SF1, the start-up processing execution unit 101f executes the start-up processing. In step SF2, the controller 100 and the print head 1 are brought into a printable state. In step SF3, the determination unit 101e determines whether or not the error detection unit 101b has detected an error, that is, the above-described factor as a factor that hinders normal printing. In a case where the error detection unit 101b detects an error, the process proceeds to step SF4, an error is generated, a busy state is set, and printing is not executed. In step SF5, a recovery operation such as cleaning is executed. In step SF6, it is determined whether or not a factor that hinders normal printing continues. In a case where the factor that hinders normal printing continues, the process proceeds to step SF7, and it is determined whether or not the recovery operation of step SF5 has been retried a predetermined number of times. In step SF8, in a case where the recovery operation is retried a predetermined number of times, the self-recovery operation is stopped, and the cleaning operation by the cleaning and placing unit 200 or the handling by the user is prompted.

In a case where NO is determined in step SF3, the process proceeds to step SF9, and it is determined whether or not a trigger output from the workpiece detection sensor 901 is input. In a case where the trigger output from the workpiece detection sensor 901 is not input, the process returns to step SF2. In a case where the trigger output from the workpiece detection sensor 901 is input, the process proceeds to step SF10, and the printing operation is executed.

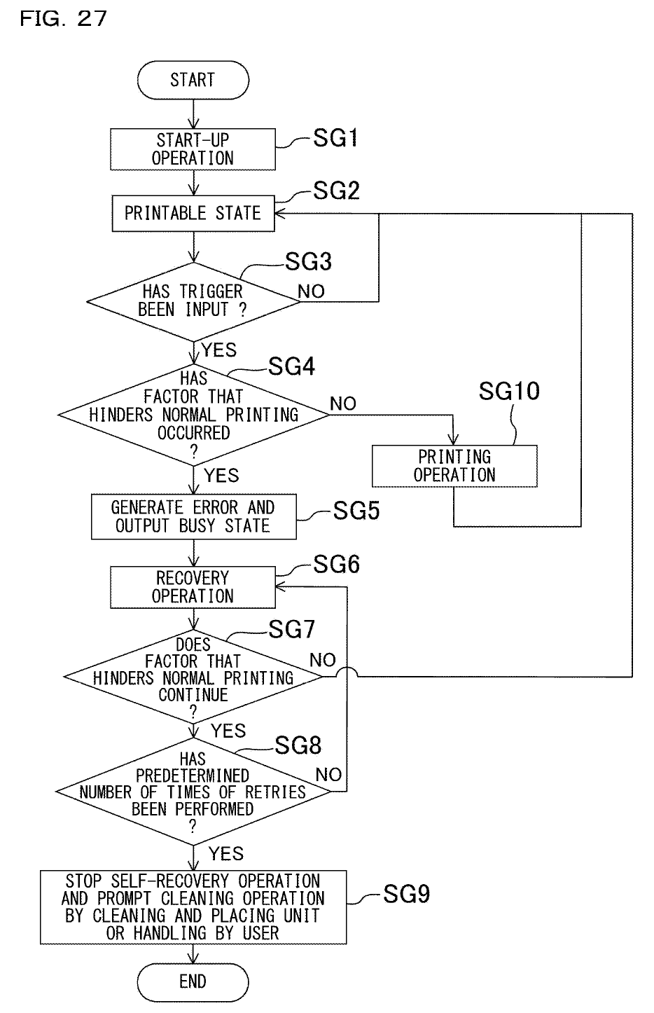

FIG. 27 is a flowchart illustrating processing in a case where an error is output after a trigger is input. After the start, in step SG1, the start-up processing execution unit 101f executes the start-up processing. In step SG2, the controller 100 and the print head 1 are brought into a printable state. In step SG3, it is determined whether or not a trigger output from the workpiece detection sensor 901 is input. In a case where the trigger output from the workpiece detection sensor 901 is not input, the process returns to step SG2.

In a case where the trigger output from the workpiece detection sensor 901 is input, the process proceeds to step SG4, and the determination unit 101e determines whether or not the error detection unit 101b has detected an error, that is, a factor that hinders normal printing. In a case where the error detection unit 101b detects an error, the process proceeds to step SG5, an error is generated, a busy state is set, and printing is not executed. In step SG6, a recovery operation such as cleaning is executed. In step SG7, it is determined whether or not a factor that hinders normal printing continues. In a case where the factor that hinders normal printing continues, the process proceeds to step SG8, and it is determined whether or not the recovery operation of step SG6 has been retried a predetermined number of times. In step SG9, in a case where the recovery operation is retried a predetermined number of times, the self-recovery operation is stopped, and the cleaning operation by the cleaning and placing unit 200 or the handling by the user is prompted.

In a case where NO is determined in step SG4, the printing operation is executed, and the process proceeds to step SG2. Furthermore, in a case where NO is determined in step SG7, the process returns to step SG2.

The above-described embodiments are merely examples in all respects, and should not be construed in a limiting manner. Moreover, all modifications and changes falling within the equivalent scope of the claims are within the scope of the invention.

### Maintenance operation according to error type

In the above-described embodiment, a cleaning operation in a case where an error related to ink contamination of the print head 1 occurs has been mainly described as one aspect of the invention, but the invention is not limited thereto. That is, since the cleaning operation in the ink jet recording apparatus I can also be referred to as an operation for maintaining the normal operation of the ink jet recording apparatus I, it can also be defined as a type of maintenance operation. Then, since the above-described cleaning operation includes cleaning of the print head 1, cleaning of the charging electrode 13, cleaning of the deflection electrode 15, and the like, it can also be defined as a maintenance operation for the entire apparatus.

For example, the error detection unit 101b may detect not only an error related to ink contamination of the print head 1 but also an error related to a component inside the controller 100. Then, according to the type of detected error, the control unit 101 can execute various maintenance operations using ink or a solvent, such as sticking release processing of a pump and ink circulation, not limited to the cleaning operation.

Errors detected by the error detection unit 101b can be broadly classified into, for example, errors originating from the print head 1 and errors originating from the controller 100, depending on the place of occurrence. Examples of the error originating from the print head 1 include a clogging error of the print nozzle 12, an error related to the charging electrode 13, an error of the deflection electrode 15, and an axis deviation error (an error in which the flight axis of ink deviates). On the other hand, examples of the error originating from the controller 100 include an abnormality in ink pressure (low or high pressure), an axis deviation error caused by a defect (problem) of the pumps (P1 to P4), an error related to the viscometer 46, and a warning of ink sticking due to a long-term stop.

When the error detection unit 101b detects an error, the control unit 101 first executes a diagnosis mode to identify the root cause of the error. In the diagnosis mode, for example, information from sensors and the like provided in each part of the apparatus, such as the pressure sensor 108c, the flow rate sensor 108d, the gutter sensor 16b, the viscometer 46, and the pressure gauge 49, is comprehensively analyzed. Then, according to the identified type of error, a correspondence table stored in advance in the storage unit 102 is referred to, and an optimal maintenance operation is automatically selected and executed.

A table (information) showing an example of a correspondence relationship between error types and maintenance operations will be described below. (1) In a case where the place of occurrence is the print head 1, as the error type, for example, a "nozzle clogging error", a "charging electrode related error", a "deflection electrode error", or an "axis deviation error" can be considered. In the case of these error types, "one-shot ASC" may be executed (selected) as the maintenance operation. This is an operation of ejecting a very small amount of solvent from the print head 1 to perform cleaning, and for example, the short-time ejection from the cleaning nozzle 17 described in step SB8 of FIG. 8 or the nozzle dissolving cleaning processing described with reference to FIGS. 11A-11C may be performed. Furthermore, in a case where the error type is a "deflection electrode error", "mist cleaning" may be executed (selected) as the maintenance operation. This is an operation of supplying a solvent and air to the print head 1 and atomizing the solvent with high-pressure air to perform cleaning, and for example, the basic cleaning operation described with reference to FIG. 7 may be performed.

(2) In a case where the place of occurrence is the controller 100, as the error type, for example, "low ink pressure", "axis deviation error", "viscometer related error", or "long-term stop warning" can be considered. First, in a case where the error type is "low ink pressure", the control unit 101 diagnoses that there is a possibility that sticking of the third pump P3 as an ink pump is the cause. In this case, "sticking release" may be executed (selected) as the maintenance operation. Specifically, the control unit 101 sends ink or a solvent to the third pump P3 using a circulation pump (for example, the first pump P1 or the second pump P2), releases the sticking of the third pump P3, and recovers the third pump P3. Next, in a case where the error type is "axis deviation error", the control unit 101 diagnoses that there is a possibility that sticking of the fourth pump P4 as a gutter pump is the cause. In this case as well, "sticking release" may be executed (selected) as the maintenance operation. Specifically, the control unit 101 sends ink or a solvent to the fourth pump P4 using a circulation pump (for example, the first pump P1 or the second pump P2) to recover the fourth pump P4. Next, in a case where the error type is "viscometer related error", the control unit 101 diagnoses that there is a possibility that sticking of the first pump P1 as a circulation pump is the cause. In this case as well, "sticking release" may be executed (selected) as the maintenance operation. Specifically, the control unit 101 sends a solvent to the first pump P1 using the second pump P2 as a solvent pump to recover the first pump P1. Finally, in a case where the error type is "long-term stop warning", in order to prevent ink sticking in advance, "ink circulation (sticking prevention)" may be executed (selected) as the maintenance operation. As a detailed operation, the control unit 101 circulates the ink through each path and returns it to the ink tank 106.

A specific example of "sticking release processing" as a maintenance operation will be described with reference to FIG. 17. For example, in a case where sticking of the first pump P1 is detected, the control unit 101, on the premise that the second pump P2 is normal, brings the 28th valve V28, the 16th valve V16, the 13th valve V13, and the third valve V3 into an open state. Then, the control unit 101 drives the second pump P2 to suck a solvent from the solvent cartridge 51 and supplies the solvent to a path including the first pump P1. Therefore, the sticking of the first pump P1 is physically released by applying a liquid feeding pressure while dissolving the ink component stuck inside and around the first pump P1 with the solvent. Such sticking release processing can be executed in-line, for example, without stopping the production line.

Furthermore, "ink circulation" as a maintenance operation may be executed as part of the sticking release processing. For example, in the sticking release processing of the third pump P3 illustrated in FIG. 18, the sticking of the third pump P3 is released by driving the first pump P1 and the second pump P2 to circulate the ink or solvent in the ink tank 106 through the peripheral path of the third pump P3. Similarly, in the sticking release processing of the fourth pump P4 illustrated in FIG. 19, the first pump P1 and the second pump P2 are driven to circulate the ink or solvent through the peripheral path of the fourth pump P4. Furthermore, as a maintenance operation for preventing sticking of the entire ink due to a long-term stop, an operation of circulating the ink between the ink tank 106 and the print head 1 using the fourth path R4 illustrated in FIG. 5, or an operation of circulating the ink in the path in the controller 100 in a state where the head module 1B is removed as illustrated in FIG. 23 is executed. These operations are also included in the maintenance operations automatically executed by the control unit 101 according to the type of error (or a sign thereof).

As described above, the ink jet recording apparatus according to the disclosure can be used, for example, in a case where printing is performed on various workpieces or the like.

What is claimed is:

1. An ink jet recording apparatus comprising:
a print head configured to accommodate a print nozzle configured to eject particulate ink, a charging electrode configured to charge the particulate ink ejected from the print nozzle, a deflection electrode configured to deflect a flight direction of the ink charged by the charging electrode, and a gutter configured to collect the ink not deflected by the deflection electrode, the print head being configured to eject the ink deflected by the deflection electrode to an outside;
a controller including a pump, configured to supply ink or a solvent to the print head using the pump and send a control signal for controlling the print nozzle, the charging electrode, and the deflection electrode to the print head; and
a connection cable configured to fluidly and electrically connect the print head and the controller, the ink jet recording apparatus being configured to perform printing on a workpiece flowing through a production line in a state where the print head is installed in the production line,
wherein the controller includes:
an error detection unit configured to detect an error related to ink contamination of at least one of the print nozzle, the charging electrode, the deflection electrode, and the gutter provided in the print head, or an error related to a problem of the pump provided in the controller; and
a control unit configured to execute, in a state where the print head is installed in a production line, at least one maintenance operation among a plurality of different maintenance operations using ink or a solvent, according to a type of the error detected by the error detection unit.

2. The ink jet recording apparatus according to claim 1, wherein
the print head includes an air injection unit configured to inject high-pressure air, and
the control unit cleans the print head by atomizing a solvent supplied into the print head with the high-pressure air injected from the air injection unit according to a type of the error detected by the error detection unit.

3. The ink jet recording apparatus according to claim 2, wherein
the control unit supplies a solvent into the print head in a shaft shape during an in-line cleaning operation, and
the air injection unit applies high-pressure air to the solvent having a shaft shape to atomize the solvent.

4. The ink jet recording apparatus according to claim 1, wherein
the print head includes, separately from the print nozzle, a cleaning nozzle configured to eject a solvent to the print head via the connection cable, and
the control unit cleans the print head with the solvent ejected from the cleaning nozzle according to a type of the error detected by the error detection unit.

5. The ink jet recording apparatus according to claim 4, wherein the control unit applies the solvent ejected from the cleaning nozzle to the print head.

6. The ink jet recording apparatus according to claim 1, wherein the control unit cleans the print head by circulating a solvent in an ink path inside the print head according to a type of the error detected by the error detection unit.

7. The ink jet recording apparatus according to claim 2, wherein
the error detection unit detects at least one of an error of the deflection electrode, a contamination error in the print head, and an error of the charging electrode as an error related to the ink contamination, and
when the error detection unit detects at least one of the error of the deflection electrode, the contamination error in the print head, and the error of the charging electrode, the control unit cleans the print head by atomizing a solvent supplied into the print head with the high-pressure air injected from the air injection unit.

8. The ink jet recording apparatus according to claim 4, wherein
the error detection unit detects a clogging error of the print nozzle as an error related to the ink contamination, and
when the error detection unit detects the clogging error of the print nozzle, the control unit cleans the print head with a solvent ejected from the cleaning nozzle.

9. The ink jet recording apparatus according to claim 1, wherein the controller includes a cleaning management unit configured to manage a usage amount of a solvent supplied during an in-line cleaning operation by the control unit.

10. The ink jet recording apparatus according to claim 2, wherein the controller includes an air generation unit configured to generate air injected from the air injection unit.

11. The ink jet recording apparatus according to claim 1, further comprising a cleaning and placing unit that is disposed at a location different from an installation location of the print head installed in the production line, and on which the print head is placed when the print head is cleaned using a solvent,
wherein in a case where the error detection unit detects an error related to the ink contamination after an in-line cleaning operation by the control unit, the controller prompts a user to perform cleaning by the cleaning and placing unit.

12. The ink jet recording apparatus according to claim 1, wherein in a case where the error detection unit detects an error related to the ink contamination after an in-line cleaning operation by the control unit, the controller causes the control unit to execute the in-line cleaning operation again, and in a case where the error detection unit detects an error related to the ink contamination after a plurality of times of the in-line cleaning operations by the control unit, the controller prompts a user to replace the print head.

13. The ink jet recording apparatus according to claim 1, wherein the print head includes a mounting portion detachably mounted to a member installed in the production line.

14. The ink jet recording apparatus according to claim 1, wherein in a case where the error detection unit detects an error related to the ink contamination, the controller executes control not to execute printing on the print head.

15. The ink jet recording apparatus according to claim 1, wherein
the control unit functions as a cleaning control unit configured to execute, as the maintenance operation, an in-line cleaning operation of cleaning the print head by supplying a solvent to the print head via the connection cable in a state where the print head is installed in the production line.

16. The ink jet recording apparatus according to claim 1, wherein
the error detection unit detects an error related to a problem of the pump provided in the controller, and
the control unit executes, as the maintenance operation, sticking release processing for releasing sticking of the pump.
